(19) United States
(12) Patent Application Publication
(10) Pub. No.: US 2025/0121818 A1
(43) Pub. Date: Apr. 17, 2025

(54) MACHINE LEARNING MODEL FOR PREDICTING DRIVING EVENTS

(71) Applicant: Tesla, Inc., Austin, TX (US)

(72) Inventors: Thoralf Gutierrez, Palo Alto, CA (US); James Potthast, Palo Alto, CA (US); Alex Baranau, Palo Alto, CA (US)

(73) Assignee: Tesla, Inc., Austin, TX (US)

(21) Appl. No.: 18/684,550

(22) PCT Filed: Aug. 18, 2022
(86) PCT No.: PCT/US2022/040700

§ 371 Date: Feb. 16, 2024

Related U.S. Application Data
(60) Provisional application No. 63/234,625, filed on Aug. 18, 2021.

(51) Int. Cl. B60W 30/08; B60W 50/14; G06N 20/00; G06Q 40/08

(52) U.S. Cl. CPC B60W 30/08; B60W 50/14; G06N 20/00; G06Q 40/08; B60W 2540/043

(57) ABSTRACT

A processor retrieves data associated with a set of driving sessions and generates a training dataset by labeling a first subset of data that corresponds to driving sessions that included a first event and labeling a second subset of the data that corresponds to driving sessions that included an indication of an airbag activation. The processor then trains an artificial intelligence model using the training dataset, such that trained artificial intelligence model predicts a score indicative of a likelihood of a new driving session associated with a new driver being associated with at least the first event or an airbag activation. Once trained, the processor can augment the score using data retrieved after each driving session. The processor can also notify the driver if the driver's actions has caused their score to increase/decrease and provide an underlying reason.

### CROSS-REFERENCE TO RELATED APPLICATIONS

This application claims priority to U.S. Provisional Patent Application No. 63/234,625, filed Aug. 18, 2021, which is incorporated herein by reference in its entirety for all purposes.

### TECHNICAL FIELD

The present disclosure generally relates to artificial intelligence-based modeling techniques to analyze data received from vehicle sensors.

### BACKGROUND

Current approaches to identifying the risk of collision for a driver rely on a reactive guess-and-check approach. Given the large number of parameters and attributes that can contribute to a collision, conventional methods are generally unreliable and static. Some conventional methods may use drivers' age and driving records to calculate the risk of collision, which ultimately indicates each driver's insurance premium. However, such an approach does not rely on each driver's specific behavior and driving habits. As a result, conventional approaches do not provide customized insurance premiums for drivers. Moreover, some conventional methods may also use driving event data, such as evidence of a collision or other risky behavior (e.g., moving violations), to adjust drivers' insurance premiums. Thus, conventional methods are often adjusted retroactively based on past behavior.

Some conventional software solutions attempt to improve the above-identified shortcoming by analyzing driver-specific data. However, these solutions focus on the drivers' past behavior and rely on static data (e.g., age and driving history). Moreover, given the large number of permutations of driver characteristics (e.g., a driver looking at a mobile phone) and vehicle characteristics (e.g., speed of a vehicle), these solutions relying on such limited data may be unable to adapt to understand risk in new scenarios. Further, the solutions that collect vehicle characteristics, such as on-board diagnostics, receive a limited set of data that does not adequately capture information about an event, such as a driver's actions, a driver's interactions with the vehicle, and information about the environment inside and outside of the vehicle.

### SUMMARY

For the aforementioned reasons, there is a desire for a system that can predict a risk of collision customized for each driver. Specifically, a trained artificial intelligence (AI) model can predict the risk of collision for a driver based on the driver, the vehicle, and the environment. The AI model can provide a score representing this risk of collision, and the system can continue to update this score for each trip. The system may provide this score representing the risk of collision and display underlying reasoning for a change in the score to the drivers, thereby allowing the drivers to take remedial and corrective actions.

In an embodiment, a method comprises retrieving, by a processor, data associated with a set of driving sessions; generating, by the processor, a training dataset by: labeling, by the processor, a first subset of data that corresponds to at least one driving session that included a first event; labeling, by the processor, a second subset of the data that corresponds to at least one driving session that included an indication of an airbag activation; and training, by the processor, an artificial intelligence model using the training dataset, such that the trained artificial intelligence model is configured to predict a score indicative of a likelihood of a new driving session associated with a new driver being associated with at least the first event or airbag activation.

The first event may correspond to an insurance claim.

The data may be received from a set of sensors of a set of vehicles associated with each driving session.

The at least one sensor within the set of sensors may be configured to collect data associated with forward collision warnings, braking events, autonomous driving disqualifications, autonomous steering disqualifications, or lane departures.

The method may further comprise transmitting, by the processor, the score to a software application configured to receive the score and generate an insurance rate.

The method may further comprise presenting, by the processor, the score to be displayed on an electronic device.

The electronic device may be associated with a vehicle corresponding to the new driving session.

The method may further comprise identifying, by the processor, a modification to at least one sensor.

The score may be calculated based on at least one attribute of the new driver associated with the new driving session.

The set of driving sessions may belong to a predetermined drive cycle, wherein when the processor determines that a vehicle associated with a driving session does not have network connectivity, the processor excludes the driving session from the set of driving sessions.

In another embodiment, a system comprises a computer-readable medium comprising non-transitory instructions that when executed, cause a processor to: retrieve data associated with a set of driving sessions; generate a training dataset by: labeling a first subset of data that corresponds to at least one driving session that included a first event; labeling a second subset of the data that corresponds to at least one driving session that included an indication of an airbag activation; and train an artificial intelligence model using the training dataset, such that the trained artificial intelligence model is configured to predict a score indicative of a likelihood of a new driving session associated with a new driver being associated with at least the first event or airbag activation.

The first event may correspond to an insurance claim.

The data may be received from a set of sensors of a set of vehicles associated with each driving session.

The at least one sensor within the set of sensors may be configured to collect data associated with forward collision warnings, braking events, autonomous driving disqualifications, autonomous steering disqualifications, or lane departures.

The instructions may further cause the processor to transmit the score to a software application configured to receive the score and generate an insurance rate.

The instructions may further cause the processor to present the score to be displayed on an electronic device.

The electronic device may be associated with a vehicle corresponding to the new driving session.

In another embodiment, a system comprises an artificial intelligence model; and a server in communication with the artificial intelligence model, the server configured to retrieve data associated with a set of driving sessions; generate a training dataset by label a first subset of data that corresponds to at least one driving session that included a first event; label a second subset of the data that corresponds to at least one driving session that included an indication of an airbag activation; and train the artificial intelligence model using the training dataset, such that the trained artificial intelligence model is configured to predict a score indicative of a likelihood of a new driving session associated with a new driver being associated with at least the first event or airbag activation.

The first event may correspond to an insurance claim.

The data may be received from a set of sensors of a set of vehicles associated with each driving session.

In another embodiment, a method comprises retrieving, by a processor, from at least one sensor in communication with a vehicle, data associated with a latest driving session of a driver; executing, by the processor, an artificial intelligence model using the data associated with the latest driving session to predict a first score indicative of a first likelihood of the latest driving session being associated with a collision, where the artificial intelligence model is trained based on historical driver data and historical driving session data; comparing, by the processor, the first score predicted by the artificial intelligence model with a second score previously predicted by the artificial intelligence model, the second score indicative of a second likelihood of the vehicle being involved in a collision based on historical driving session data of the driver; and when the first score is different than the second score, transmitting, by the processor, the first score to a computer model configured to receive the first score and generate an insurance value corresponding to the first likelihood of the latest driving session being associated with a collision.

The method may further comprise presenting, by the processor, for display, the first score or the insurance value on an electronic device associated with the vehicle.

The electronic device may be at least one of a display system of the vehicle or a mobile device associated with the driver of the latest driving session.

The processor may display the first score within a defined time after the latest driving session is terminated.

The first score may be calculated based on at least one attribute of the driver associated with the latest driving session.

The method may further comprise disabling, by the processor, at least one feature associated with the driver.

In another embodiment, a system comprises a computer-readable medium comprising non-transitory instructions that when executed, cause a processor to retrieve, from at least one sensor in communication with a vehicle, data associated with a latest driving session of a driver; execute an artificial intelligence model using the data associated with the latest driving session to predict a first score indicative of a first likelihood of the latest driving session being associated with a collision, where the artificial intelligence model is trained based on historical driver data and historical driving session data; compare the first score predicted by the artificial intelligence model with a second score previously predicted by the artificial intelligence model, the second score indicative of a second likelihood of the vehicle being involved in a collision based on historical driving session data of the driver; and when the first score is different than the second score, transmit the first score to a computer model configured to receive the first score and generate an insurance value corresponding to the first likelihood of the latest driving session being associated with a collision.

The instructions may further cause the processor to present, for display, the first score or the insurance value on an electronic device associated with the vehicle.

The electronic device may be at least one of a display system of the vehicle or a mobile device associated with the driver of the latest driving session.

The processor may display the first score within a defined time after the latest driving session is terminated.

The first score may be calculated based on at least one attribute of the driver associated with the latest driving session.

The instructions may further cause the processor to disable at least one feature associated with the driver.

In another embodiment, a system comprises an artificial intelligence model; and a server in communication with the artificial intelligence model, the server configured to retrieve, from at least one sensor in communication with a vehicle, data associated with a latest driving session of a driver; execute the artificial intelligence model using the data associated with the latest driving session to predict a first score indicative of a first likelihood of the latest driving session being associated with a collision, where the artificial intelligence model is trained based on historical driver data and historical driving session data; compare the first score predicted by the artificial intelligence model with a second score previously predicted by the artificial intelligence model, the second score indicative of a second likelihood of the vehicle being involved in a collision based on historical driving session data of the driver; and when the first score is different than the second score, transmit the first score to a computer model configured to receive the first score and generate an insurance value corresponding to the first likelihood of the latest driving session being associated with a collision.

The server may be further configured to present, for display, the first score or the insurance value on an electronic device associated with the vehicle.

The electronic device may be at least one of a display system of the vehicle or a mobile device associated with the driver of the latest driving session.

The server may display the first score within a defined time after the latest driving session is terminated.

The first score may be calculated based on at least one attribute of the driver associated with the latest driving session.

The server may be further configured to disable at least one feature associated with the driver.

In another embodiment, a method comprises retrieving, by a processor, driving session data of a driving session from at least one sensor configured to monitor at least one driving attribute of a vehicle and at least one camera in communication with the vehicle; executing, by the processor, an artificial intelligence model trained based on previous driver data and previous driving session data to predict a score indicative of a likelihood of the driving session being associated with an event; and presenting, by the processor, for display on an electronic device in communication with the vehicle, the score and an indicator of data associated with the likelihood of the event.

The electronic device may be a display system of the vehicle or a mobile device associated with a driver of the driving session.

The event may be a collision.

The event may be an airbag activation or a sensor identifying an impact.

The indicator of data associated with the likelihood of the event may be an image or a video captured by at least one camera.

The method may further comprise presenting, by the processor, for display on the electronic device in communication with the vehicle, a timestamp of the data associated with the likelihood of the event.

The indicator of data associated with the likelihood of the event may be a map associated with an action performed by a driver of the driving session.

The indicator of data associated with the likelihood of the event may be a timeline of the driving session.

The timeline may comprise an indicator for at least one driver action that has affected the score.

The at least one driver action may be a hard brake, unsafe following, or aggressive driving.

Execution of the artificial intelligence model and presentation of the score may be performed in real-time during the driving session.

The method may further comprise encrypting, by the processor, the score and the indicator of data associated with the likelihood of the event using an encryption key associated with the electronic device.

The at least one camera may be configured to monitor a driver of the driving session.

The indicator of data associated with the likelihood of the event may correspond to an image of the driver.

In another embodiment, a system comprises a computer-readable medium comprising non-transitory instructions that when executed, cause a processor to retrieve driving session data of a driving session from at least one sensor configured to monitor at least one driving attribute of a vehicle and one camera in communication with the vehicle; execute an artificial intelligence model trained based on previous driver data and previous driving session data to predict a score indicative of a likelihood of the driving session being associated with an event; and present for display on an electronic device in communication with the vehicle, the score and an indicator of data associated with the likelihood of the event.

The electronic device may be a display system of the vehicle or a mobile device associated with a driver of the driving session.

The event may be a collision.

The event may be an airbag activation or a sensor identifying an impact.

The indicator of data associated with the likelihood of the event may be an image or a video captured by the at least one camera.

The instructions may further cause the processor to present for display on the electronic device in communication with the vehicle, a timestamp of the data associated with the likelihood of the event.

The indicator of data associated with the likelihood of the event may be a map associated with an action performed by a driver of the driving session.

The indicator of data associated with the likelihood of the event may be a timeline of the driving session.

The timeline may comprise an indicator for at least one driver action that has affected the score.

The at least one driver action may be a hard brake, unsafe following, or aggressive driving.

The execution of the artificial intelligence model and presentation of the score may be performed in real-time during the driving session.

The instructions may further cause the processor to encrypt the score and the indicator of data associated with the likelihood of the event using an encryption key associated with the electronic device.

The at least one camera may be configured to monitor a driver of the driving session.

The indicator of data associated with the likelihood of the event may correspond to an image of the driver.

In another embodiment, a system comprises an artificial intelligence model; and a server in communication with the artificial intelligence model, the server configured to retrieve driving session data of a driving session from at least one sensor configured to monitor at least one driving attribute of a vehicle and one camera in communication with the vehicle; execute the artificial intelligence model trained based on previous driver data and previous driving session data to predict a score indicative of a likelihood of the driving session being associated with an event; and present for display on an electronic device in communication with the vehicle, the score and an indicator of data associated with the likelihood of the event.

The electronic device may be a display system of the vehicle or a mobile device associated with a driver of the driving session.

The event may be a collision.

The event may be an airbag activation or a sensor identifying an impact.

The indicator of data associated with the likelihood of the event may be an image or a video captured by the at least one camera.

The server may be further configured to present for display on the electronic device in communication with the vehicle, a timestamp of the data associated with the likelihood of the event.

The indicator of data associated with the likelihood of the event may be a map associated with an action performed by a driver of the driving session.

The indicator of data associated with the likelihood of the event may be a timeline of the driving session.

The timeline may comprise an indicator for at least one driver action that has affected the score.

The at least one driver action may be a hard brake, unsafe following, or aggressive driving.

The execution of the artificial intelligence model and presentation of the score may be performed in real-time during the driving session.

The server may be further configured to encrypt the score and the indicator of data associated with the likelihood of the event using an encryption key associated with the electronic device.

The at least one camera may be configured to monitor a driver of the driving session.

The indicator of data associated with the likelihood of the event may correspond to an image of the driver.

In another embodiment, a method comprises retrieving, by a processor, from at least one sensor in communication with a vehicle, data associated with a latest driving session of a driver; executing, by the processor, an artificial intelligence model using the data associated with the latest driving session to predict a score indicative of a likelihood of the latest driving session being associated with a collision, where the artificial intelligence model is trained based on historical driver data and historical driving session data; and modifying, by the processor, at least one functionality associated with the vehicle based on the score.

The modifying at least one functionality may correspond to a functionality associated with the driver.

The at least one functionality may correspond to at least one of an autonomous driving or autonomous steering functionality.

The at least one functionality may correspond to electronic content presented by an electronic device associated with the vehicle.

The processor may modify the at least one functionality when the score satisfies a threshold.

The at least one functionality may be modified periodically.

The at least one functionality may be associated with the vehicle is also associated with a particular driver of the vehicle.

In another embodiment, a system comprises a computer-readable medium comprising non-transitory instructions that when executed, cause a processor to retrieve from at least one sensor in communication with a vehicle, data associated with a latest driving session of a driver; execute an artificial intelligence model using the data associated with the latest driving session to predict a score indicative of a likelihood of the latest driving session being associated with a collision, where the artificial intelligence model is trained based on historical driver data and historical driving session data; and modify at least one functionality associated with the vehicle based on the score.

The modifying at least one functionality may correspond to a functionality associated with the driver.

The at least one functionality may correspond to at least one of an autonomous driving or autonomous steering functionality.

The at least one functionality may correspond to electronic content presented by an electronic device associated with the vehicle.

The instructions may further cause the processor to modify the at least one functionality when the score satisfies a threshold.

The at least one functionality may be modified periodically.

The at least one functionality associated with the vehicle may be also associated with a particular driver of the vehicle.

In another embodiment, a system comprises an artificial intelligence model; and a server in communication with the artificial intelligence model, the server configured to retrieve from at least one sensor in communication with a vehicle, data associated with a latest driving session of a driver; execute the artificial intelligence model using the data associated with the latest driving session to predict a score indicative of a likelihood of the latest driving session being associated with a collision, where the artificial intelligence model is trained based on historical driver data and historical driving session data; and modify at least one functionality associated with the vehicle based on the score.

The modifying at least one functionality may correspond to a functionality associated with the driver.

The at least one functionality may correspond to at least one of an autonomous driving or autonomous steering functionality.

The at least one functionality may correspond to electronic content presented by an electronic device associated with the vehicle.

The server may be further configured to modify the at least one functionality when the score satisfies a threshold.

The at least one functionality may be modified periodically.

The at least one functionality associated with the vehicle may be also associated with a particular driver of the vehicle.

### BRIEF DESCRIPTION OF THE DRAWINGS

Non-limiting embodiments of the present disclosure are described by way of example with reference to the accompanying figures, which are schematic and are not intended to be drawn to scale. Unless indicated as representing the background art, the figures represent aspects of the disclosure.

FIG. 1A illustrates components of an AI-enabled vehicle sensor data analysis system, according to an embodiment.

FIG. 1B illustrates components of a vehicle, according to an embodiment.

FIG. 1C illustrates components of a vehicle, according to an embodiment.

FIG. 2 illustrates a flow diagram of a process executed in an AI-enabled vehicle sensor data analysis system, according to an embodiment.

FIG. 3 illustrates a flow diagram of a process for training an AI model, according to an embodiment.

FIGS. 4A-B illustrate model feature pre-processing for driving data retrieved from one or more data sources, in accordance with different embodiments.

FIG. 5 illustrates factors analyzed by a trained AI model in an AI-enabled vehicle sensor data analysis system, according to an embodiment.

FIG. 6 illustrates a flow diagram of a process executed in an AI-enabled vehicle sensor data analysis system, according to an embodiment.

FIG. 7 illustrates a flow diagram of a process executed in an AI-enabled vehicle sensor data analysis system, according to an embodiment.

FIGS. 8A-10 illustrate graphical user interfaces presented by an AI-enabled vehicle sensor data analysis system, according to different embodiments.

FIG. 11 illustrates a drive cycle, according to an embodiment.

FIG. 12 illustrates a timeline of events for a driving session, according to an embodiment.

FIG. 13 illustrates a flow diagram of a process executed in an AI-enabled vehicle sensor data analysis system, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

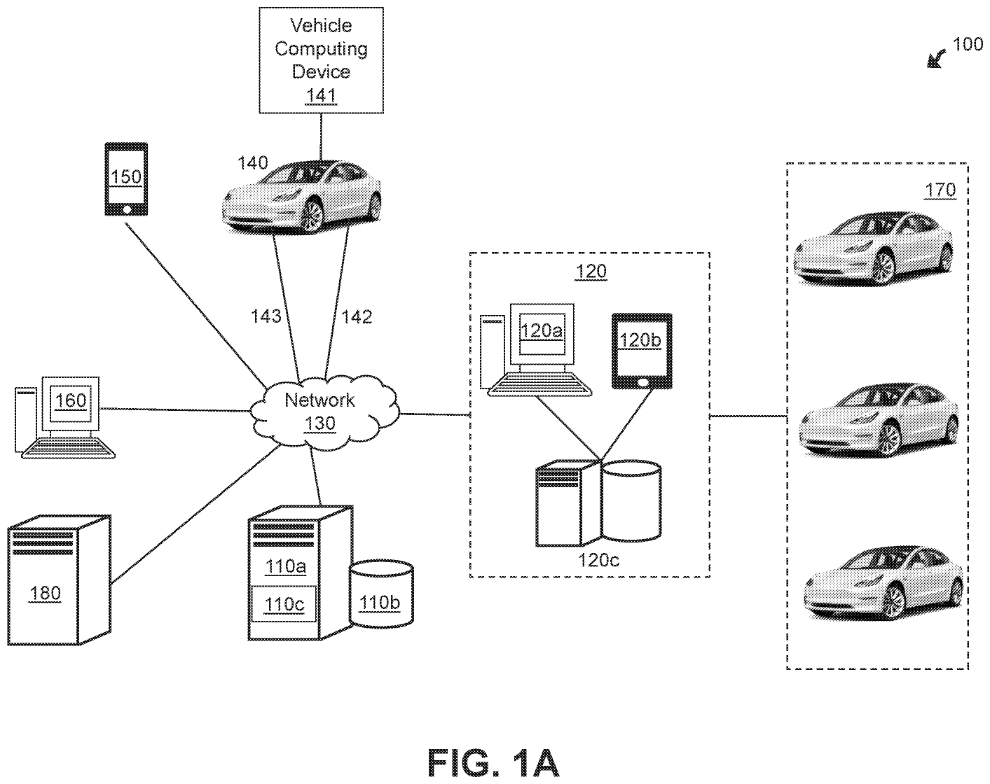

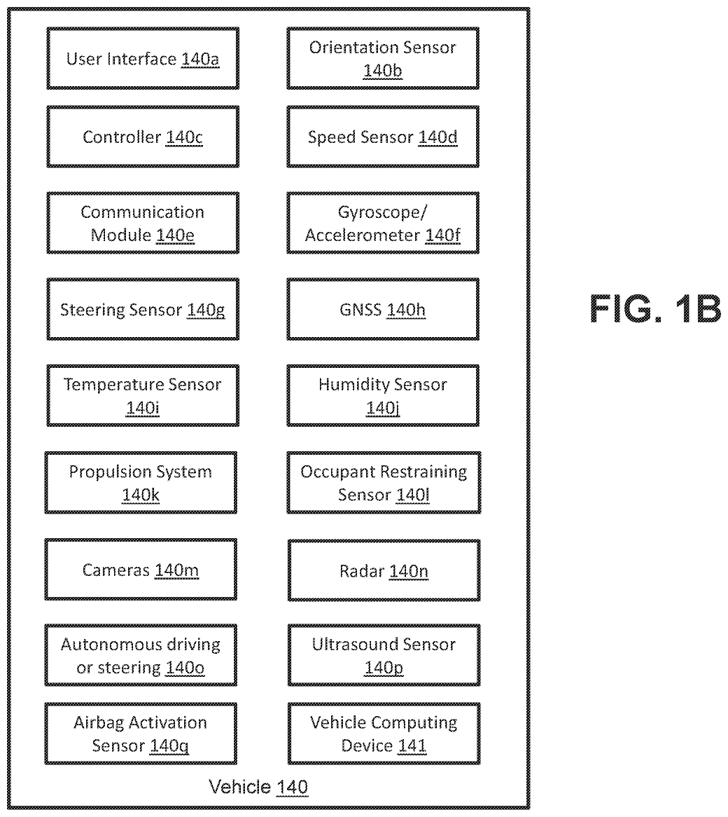

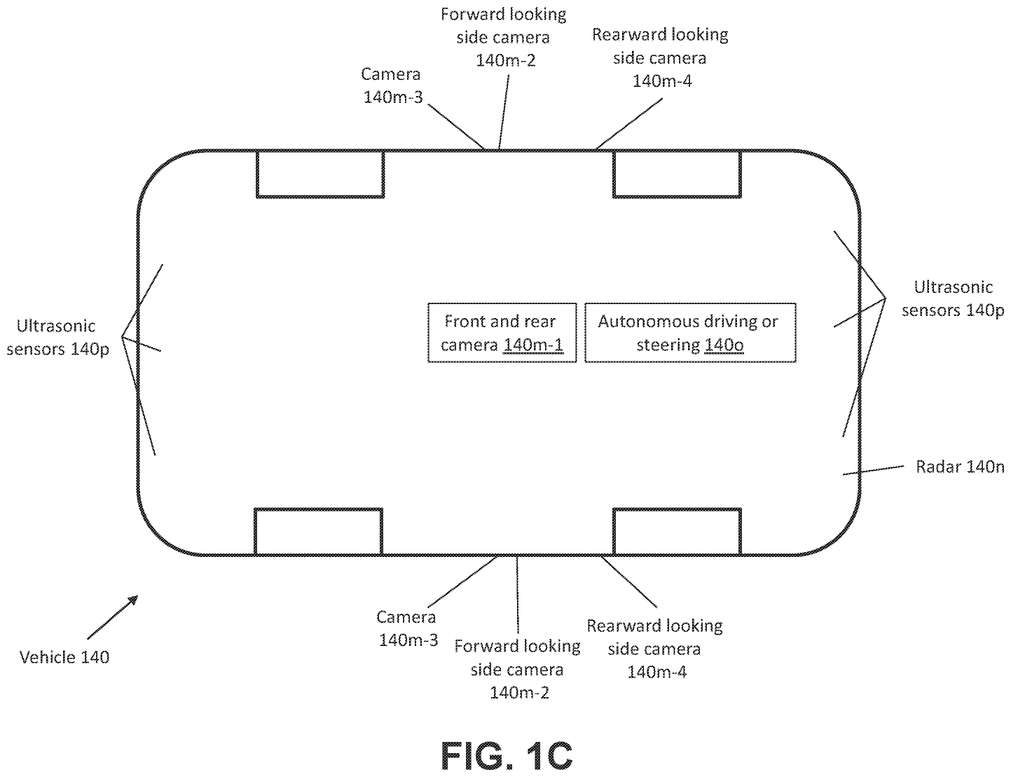

By implementing the systems and methods described herein, a system may resolve the aforementioned technical challenges and deficiencies by removing the need to use a guess-and-check approach. Instead, the methods and systems described herein may use data received from a vehicle's sensors (aggregated with driver data) and may train an AI model accordingly. The system may use the trained AI model that can predict a risk of a collision (or other events resulting in an insurance claim) for a driving session. The risk of collision may be revised based on data received from vehicle sensors each time the vehicle is involved in a driving session (e.g., with each trip that the driver takes). As a result, the overall risk of collision may be dynamically adjusted in real-time (or near real-time) based on the latest driver and/or vehicle data. FIG. 1A is a non-limiting example of components of a system in which the analytics server operates.

FIG. 1A illustrates components of an AI-enabled vehicle sensor data analysis system 100. The system 100 may include an analytics server 110a, a system database 110b, electronic data sources 120a-c (collectively electronic data sources 120), vehicle 140, the vehicle computing device 141, end-user device 150, an administrator computing device 160, vehicles 170, and a third party server 180. The above-mentioned components may be connected through a network 130. Examples of the network 130 may include, but are not limited to, private or public LAN, WLAN, MAN, WAN, and the Internet. The network 130 may include wired and/or wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, for example, a GSM (Global System for Mobile Communications), CDMA (Code Division Multiple Access), or an EDGE (Enhanced Data for Global Evolution) network.

The system 100 is not confined to the components described herein and may include additional or other components, not shown for brevity, which are to be considered within the scope of the embodiments described herein.

The analytics server 110a may generate and display an electronic platform configured to train and/or use various computer models (including AI and/or machine learning models, such as the AI model(s) 110c) to use driving and vehicle data (e.g., training dataset) and predict a score for the driver indicative of a likelihood of a collision or any other predetermined event (e.g., airbag activation). In FIG. 1A, the AI model(s) 110c are illustrated as a component of the analytics server 110a, but the AI model(s) 110c may be stored in a separate component. The electronic platform may include graphical user interfaces (GUIs) displayed on the electronic data source 120, the end-user device 150, vehicle computing device 141, and/or the administrator computing device 160. An example of the electronic platform generated and hosted by the analytics server 110a may be a web-based application or a website configured to be displayed on different electronic devices, such as mobile and wearable devices, tablets, personal computers, and the like.

The score for the driver may represent a likelihood of a collision based on the driver, the vehicle, and the environment. In one example, the score can range from 0 to 1. In another example, the score can range from 1-100 or 0-100. In another example, the score can be a letter grade, such as A, B, C, D, or F. The score can be associated with a risk class, so a sub-range of scores can represent a high-risk class and another sub-range of scores can represent a low-risk class. The risk class may be used to adjust an insurance premium accordingly. As described herein, the score can be updated after each driving session or after a period of time. In one configuration, the score can be presented for display and dynamically change during a driving session.

The analytics server 110a may host a website accessible to users operating any of the electronic devices described herein (e.g., end-users), where the content presented via the various webpages may be controlled based upon the roles and/or viewing permissions of each particular user. The analytics server 110a may be any computing device comprising a processor and non-transitory machine-readable storage capable of executing the various tasks and processes described herein. Non-limiting examples of such computing devices may include workstation computers, laptop computers, server computers, and the like. While the system 100 includes a single analytics server 110a, the system 100 may include any number of computing devices operating in a distributed computing environment, such as a cloud environment.

The analytics server 110a may execute software applications configured to display the electronic platform (e.g., host a website), which may generate and serve various webpages to each electronic data source 120 and/or end-user devices 150. Different users may use the website to view and/or interact with predicted results from the AI model(s) 110c.

The analytics server 110a may be configured to require user authentication based upon a set of user authorization credentials (e.g., username, password, biometrics, cryptographic certificate, and the like). The analytics server 110a may access the system database 110b configured to store user credentials, which the analytics server 110a may be configured to reference in order to determine whether a set of entered credentials (purportedly authenticating the user) match an appropriate set of credentials that identify and authenticate the user.

The analytics server 110a may generate and host webpages based upon a particular user's role within the system 100. In such implementations, the user's role may be defined by data fields and input fields in user records stored in the system database 110b. The analytics server 110a may authenticate the user and may identify the user's role by executing an access directory protocol (e.g. LDAP). The analytics server 110a may generate webpage content that is customized according to the user's role defined by user records in the system database 110b.

The electronic data sources 120 may represent various electronic data sources that contain, retrieve, and/or input data associated with previous (or current) driving sessions. The electronic data sources 120 may include a server 120c that collects data provided by vehicles 170. Although depicted as a server and a database, it is intended that this component represent a server, a database, a server communicatively coupled to a database, a server incorporating a database, or the like. For instance, the analytics server 110a may obtain driving session and/or driver data from the server 120c to be used by the AI model(s) 110c. A computer 120a or a technician device 120b may be used as input devices to store additional data, including observations, visual data, testing, diagnostics, etc., into the server 120c. The data collected and aggregated by the electronic data sources 120 may include driver attributes (e.g., driver's age, sex, demographic data, and driving record) and corresponding driving session data for each driver (e.g., data collected using telemetry sensors of vehicles driven by each driver).

The server 120c is communicatively coupled to the vehicles 170 and may be configured to receive data from the vehicles 170 on a continuous or periodic basis. The electronic data sources may actively monitor the vehicles 170, aggregate driving session data, and aggregate driver behavior data. As shown in FIG. 1B, each vehicle 170 may include sensors configured to collect and transmit driver behavior data and other data associated with each driving session. Each vehicle 170 may include one or more of these sensors and may transmit their data to one or more of the data repositories within the electronic data sources 120. For instance, the server 120c may use an application programming interface to collect and aggregate data from each vehicle 170 and store the data.

The driving session data retrieved from sensors in communication with each vehicle 170 may also include an indication of whether it included an event. As used herein, an event may refer to any predetermined action associated with a driving session. For instance, an event may refer to an indication of a collision (e.g., activation of an airbag or any other collision indicator monitored by a sensor). As used herein, a driving session corresponds to a trip where the vehicle is driven, regardless of whether the trip ends at a final destination. The driving session starts when the vehicle is engaged from Park to Drive/Reverse and moves beyond a threshold distance (e.g., 0.5 miles). The driving session may end when the vehicle is engaged back to Park and turned off, and in some embodiments, when the driver leaves the vehicle. The system (e.g., the analytics server 110a or the server 120c) may employ the use of one or more sensors to determine whether the driver has left the driver's seat. However, this definition and threshold can be revised using the administrator computing device 160.

The vehicles 170 may represent a collection of vehicles monitored by the analytics server 110a to train the AI model(s) 110c. For instance, a driver for each vehicle 170 may authorize the analytics server 110a to monitor data associated with their respective vehicle. As a result, the analytics server 110a may utilize various methods discussed herein to collect sensor data (via the electronic data sources 120) and generate a training dataset to train the AI model(s) 110c accordingly. The analytics server 110a may then apply the trained AI model(s) 110c to analyze data associated with the vehicle 140 and to predict a score for the driver of the vehicle 140. Moreover, the data associated with the vehicle 140 can also be processed and added to the training dataset, such that the analytics server 110a re-calibrates the AI model(s) 110c accordingly and improves their accuracy. Therefore, the vehicle 140 can also be a part of the collection of vehicles monitored by the analytics server 110a to train the AI model(s) 110c. For illustration purposes, FIG. 1A depicts a subject vehicle as the vehicle 140 and depicts other vehicles that contribute to the set of data for training and updating the AI model(s) 110c.

Sensors for each vehicle 170 and/or vehicle 140 may monitor and transmit the collected data associated with different driving sessions to the electronic data sources 120. In another example, the electronic data sources 120 may include third-party data. For instance, the server 120c may retrieve driver and/or driving session data from a third party, such as a third-party sensor manufacturers, insurance company, collision centers, and/or other vehicle manufacturers. The analytics server 110a may then use the data stored within the electronic data sources 120 to generate training datasets and train the AI model(s) 110c discussed herein.

FIG. 1B illustrates a block diagram of sensors integrated within the vehicle 140, according to an embodiment. The vehicle 140 may represent any of the vehicles depicted in FIG. 1A, including vehicles 170.

As discussed herein, different sensors integrated within the vehicle 140 may be configured to measure various data associated with each driving session for the vehicle 140. The analytics server may periodically collect data monitored and collected by these sensors where the data is processed in accordance with the methods described herein and used to train the AI model and/or execute the AI model to identify a new score. Moreover, the analytics server may analyze various data monitored and collected by each sensor to identify additional data associated with each driving session. For instance, the analytics server may analyze data collected by the camera 140m to determine whether the driver was distracted during a driving session.

The vehicle 140 may include a user interface 140a. The user interface 140a may refer to a user interface of the vehicle computing device (e.g., the vehicle computing device 141 in FIG. 1A). The user interface 140a may be implemented as a display screen integrated with or coupled to an interior of the vehicle, a heads-up display, a touchscreen, or the like. The user interface 140a may include an input device, such as a touchscreen, knobs, buttons, a keyboard, a mouse, a joystick, a gesture sensor, a steering wheel, or the like. In various embodiments, the user interface 140a may be adapted to provide user input (e.g., as a type of signal and/or sensor information) to other devices or sensors of the vehicle 170 (e.g., sensors illustrated in FIG. 1B), such as a controller 140c.

The vehicle 140 may communicate with the analytics server 110a via two separate data streams (e.g., data stream 142 and data stream 143). The vehicle 140 may transmit driving data indicating the driver's driving behavior and how the vehicle 140 was operated via the data stream 142. The vehicle 140 may also transmit connectivity data using the data stream 143. The vehicle 140 may transmit data that indicates whether the vehicle 140 was properly connected to a network (e.g., via wireless or wired communication protocols). Therefore, the data stream 143 indicates whether the vehicle 140 was functionally able to transmit the stream 142 to the analytics server 110a.

By bifurcating the data transmitted to the analytics server 110a into two separate data streams, the vehicle 140 may ensure that the analytics server 110a aggregates the correct data into the driving cycles and analyzes data truly indicating the latest drive cycle of the vehicle 140. As described herein, the analytics server 110a may dynamically revise the data included within the drive cycle based on whether the vehicle 140 was properly connected to a network and able to transmit data. For brevity, FIG. 1A only depicts the data streams associated with the vehicle 140. However, the vehicles 170 may also use a similar method to indicate whether each vehicle 170 was properly connected to a network and able to transmit driving data to the analytics server 110a.

The user interface 140a may also be implemented with one or more logic devices that may be adapted to execute instructions, such as software instructions, implementing any of the various processes and/or methods described herein. For example, the user interface 140a may be adapted to form communication links, transmit and/or receive communications (e.g., sensor signals, control signals, sensor information, user input, and/or other information), or to perform various other processes and/or methods. In another example, the driver may use the user interface 140a to control the temperature of the vehicle 140 or activate its features (e.g., autonomous driving or steering 1400). Therefore, the user interface 140a may monitor and collect driving session data in conjunction with other sensors described herein.

The user interface 140a may also monitor how the driver interacts with the vehicle computing device. For instance, the user interface 140a may monitor how frequently the driver interacts with the touchscreen or whether the driver controls the infotainment system of the vehicle 140 (e.g., increases music volume) via the touchscreen or input elements of the steering wheel.

An orientation sensor 140b may be implemented as one or more of a compass, float, accelerometer, and/or other digital or analog device capable of measuring the orientation of vehicle 140 (e.g., magnitude and direction of roll, pitch, and/or yaw, relative to one or more reference orientations such as gravity and/or Magnetic North). The orientation sensor 140b may be adapted to provide heading measurements for the vehicle 140. In other embodiments, the orientation sensor 140b may be adapted to provide roll, pitch, and/or yaw rates for vehicle 140 using a time series of orientation measurements. The orientation sensor 140b may be positioned and/or adapted to make orientation measurements in relation to a particular coordinate frame of vehicle 140.

A controller 140c may be implemented as any appropriate logic device (e.g., processing device, microcontroller, processor, application-specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the vehicle 140. Such software instructions may also implement methods for processing sensor signals, determining sensor information, providing user feedback (e.g., through user interface 140a), querying devices for operational parameters, selecting operational parameters for devices, or performing any of the various operations described herein.

A communication module 140e may be implemented as any wired and/or wireless interface configured to communicate sensor data, configuration data, parameters, and/or other data and/or signals to any feature shown in FIG. 1A (e.g., analytics server 110a and/or electronic data sources 120). As described herein, in some embodiments, communication module 140e may be implemented in a distributed manner such that portions of communication module 140e are implemented within one or more elements and sensors shown in FIG. 1B. In some embodiments, the communication module 140e may delay communicating sensor data. For instance, when the vehicle 140 does not have network connectivity, the communication module 140e may store sensor data within a temporary data storage and transmit the sensor data when the vehicle 140 is identified as having proper network connectivity.

A speed sensor 140d may be implemented as an electronic pitot tube, metered gear or wheel, water speed sensor, wind speed sensor, a wind velocity sensor (e.g., direction and magnitude), and/or other devices capable of measuring or determining a linear speed of the vehicle 140 (e.g., in a surrounding medium and/or aligned with a longitudinal axis of vehicle 140) and providing such measurements as sensor signals that may be communicated to various devices.

A gyroscope/accelerometer 140f may be implemented as one or more electronic sextants, semiconductor devices, integrated chips, accelerometer sensors, and systems, or other devices capable of measuring angular velocities/accelerations and/or linear accelerations (e.g., direction and magnitude) of the vehicle 140 and providing such measurements as sensor signals that may be communicated to other devices, such as the analytics server. The gyroscope/accelerometer 140f may be positioned and/or adapted to make such measurements in relation to a particular coordinate frame of the vehicle 140. In various embodiments, the gyroscope/accelerometer 140f may be implemented in a common housing and/or module with other elements depicted in FIG. 1B to ensure a common reference frame or a known transformation between reference frames.

A global navigation satellite system (GNSS) 140h may be implemented as a global positioning satellite receiver and/or other device capable of determining absolute and/or relative positions of the vehicle 140 based on wireless signals received from space-born and/or terrestrial sources, for example, and capable of providing such measurements as sensor signals that may be communicated to various devices. In some embodiments, the GNSS 140h may be adapted to determine a velocity, speed, and/or yaw rate of the vehicle 140 (e.g., using a time series of position measurements), such as an absolute velocity and/or a yaw component of an angular velocity of the vehicle 140.

A temperature sensor 140i may be implemented as a thermistor, electrical sensor, electrical thermometer, and/or other devices capable of measuring temperatures associated with vehicle 140, and providing such measurements as sensor signals. The temperature sensor 140i may be configured to measure an environmental temperature associated with the vehicle 140, such as a cockpit or dash temperature, for example, that may be used to estimate a temperature of one or more elements of the vehicle 140.

A humidity sensor 140j may be implemented as a relative humidity sensor, electrical sensor, electrical relative humidity sensor, and/or other device capable of measuring a relative humidity associated with the vehicle 140 and providing such measurements as sensor signals.

A steering sensor 140g may be adapted to physically adjust a heading of the vehicle 140 according to one or more control signals and/or user inputs provided by a logic device, such as controller 140c. Steering sensor 140g may include one or more actuators and control surfaces (e.g., a rudder or other type of steering or trim mechanism) of the vehicle 140, and may be adapted to physically adjust the control surfaces to a variety of positive and/or negative steering angles/positions. The steering sensor 140g may also be adapted to sense a current steering angle/position of such steering mechanism and provide such measurements.

A propulsion system 140k may be implemented as a propeller, turbine, or other thrust-based propulsion system, a mechanical wheeled and/or tracked propulsion system, a sail-based propulsion system, and/or other types of propulsion systems that can be used to provide motive force to the vehicle 140. The propulsion system 140k may also monitor the direction of the motive force and/or thrust of the vehicle 140 relative to a coordinate frame of the vehicle 140. In some embodiments, the propulsion system 140k may be coupled to and/or integrated with the steering sensor 140g.

An occupant restraint sensor 140l may monitor seatbelt detection and locking/unlocking assemblies, as well as other passenger restraint subsystems. The occupant restraint sensor 140l may include various environmental and/or status sensors, actuators, and/or other devices facilitating operation of safety mechanisms associated with operation of the vehicle 140. For example, occupant restraint sensor 140l may be configured to receive motion and/or status data from other sensors depicted in FIG. 1B. The occupant restraint sensor 140l may determine whether safety measurements (e.g., seatbelts) are being utilized.

Cameras 140m may refer to one or more cameras integrated within the vehicle 140 and may include multiple cameras integrated into (or retrofitted) the vehicle 140, as depicted in FIG. 1C. The cameras 140m may be interior-facing or exterior-facing cameras of the vehicle 140. For instance, as depicted in FIG. 1C, the vehicle 140 may include one or more interior-facing cameras 140m-1. These cameras may monitor and collect footage of the occupants of the vehicle 140. The vehicle 140 may also include a forward-looking side camera 140m-2, camera 140m-3 (e.g., integrated within the door frame), and rearward-looking side camera 140m-4.

Referring back to FIG. 1B, a radar 140n and an ultrasound sensors 140p may be configured to monitor the distance of the vehicle 140 to other objects, such as other vehicles or immobile objects (e.g., trees or garage door). The radar 140n and the ultrasound sensors 140p may be integrated into the vehicle 140 as depicted in FIG. 1C. The vehicle 140 may also include an autonomous driving or steering feature 140o configured to use data collected via various sensors (e.g., radar 140n, speed sensor 140d, and/or the ultrasound sensors 140p) to autonomously navigate the vehicle 140. Therefore, the autonomous driving or steering 140o may analyze various data collected by one or more sensors described herein to identify driving data. For instance, the autonomous driving or steering 140o may calculate a risk of forward collision based on a speed of the vehicle 140 and its distance to another vehicle on the road. The autonomous driving or steering 140o may also determine whether the driver is no longer touching the steering wheel. The autonomous driving or steering 140o may transmit the analyzed data to various features discussed herein, such as the analytics server.

An airbag activation sensor 140q may anticipate or detect a collision and cause activation or deployment of one or more airbags. The airbag activation sensor 140q may transmit data regarding the deployment of an airbag, including data associated with the event causing the deployment.

Referring back to FIG. 1A, the end-user device 150 may be any computing device comprising a processor and a non-transitory machine-readable storage medium capable of performing the various tasks and processes described herein. For example, the AI model(s) 110c described herein may be stored and performed (or directly accessed) by end-user device 150. Non-limiting examples of an end-user device 150 may be a workstation computer, laptop computer, tablet computer, and server computer. In operation, various users may use end-user devices 150 to access the GUI operationally managed by the analytics server 110a.

In operation, the end-user device 150 may be a computing device operated by the driver of the vehicle 140. The end-user device 150 may execute an application (e.g., an application or browser on a mobile device) in communication with the analytics server 110a. Using the application, the end-user device 150 may display the GUIs and notifications described herein.

The administrator computing device 160 may represent a computing device operated by a system administrator. The administrator computing device 160 may be configured to display data retrieved or generated by the analytics server 110a (e.g., various analytic metrics and risk scores) where the system administrator can monitor various models utilized by the analytics server 110a, electronic data sources 120, and/or end-user devices 150; review feedback; and/or facilitate the training of the AI model(s) 110c that are maintained by the analytics server 110a.

In a non-limiting example, the administrator computing device 160 may provide instructions to the analytics server 110a to train the machine learning model(s) 110c to predict a score. To do so, the administrator computing device 160 may generate a training dataset stored in the electronic data source 120c by creating a labeled dataset comprising driver and vehicle data known to be indicative of a collision or a predetermined event (e.g., activation of an airbag). The administrator computing device 160 may label data and/or mask personally identifiable information (PII) associated with different datasets. In some configurations, a processor of the vehicle 170 and/or 140 may remove the PII by masking the data (e.g., generating a pseudonym for the driver or the vehicle itself). The analytics server 110a may then use the labeled data to train the AI model(s) 110c. The administrator computing device 120b or the analytics server 110a may then feed the labeled dataset into one or more AI model(s) 110c configured to ingest the labeled data to train itself accordingly. Upon the AI model(s) 110c being sufficiently trained, the analytics server 110a may use the trained AI model(s) 110c to predict an overall risk of collision for a driver. As will be described below, the AI model(s) 110c may also update the risk using new driving/vehicle information.

The vehicle 140 may be any vehicle having telemetry sensors. The vehicle 140 may also include a vehicle computing device 141. The vehicle computing device 141 may control the presentation of content on an infotainment system of the vehicle, process commands associated with the infotainment system, aggregate sensor data, manage communication of data to an electronic data source, receive updates, and/or transmit messages. In one configuration, the vehicle computing device 141 communicates with an electronic control unit. In another configuration, the vehicle computing device 141 is an electronic control unit. The vehicle computing device 141 may comprise a processor and a non-transitory machine-readable storage medium capable of performing the various tasks and processes described herein. For example, the AI model(s) 110c described herein may be stored and performed (or directly accessed) by the vehicle computing device 141. Non-limiting examples of the vehicle computing device 141 may include a vehicle multimedia and/or display system.

In operation, the electronic data sources 120 may collect driving session data and driver data from various electronic sources including vehicles 170 and third-party servers (e.g., insurance companies, collision centers, or other vehicle manufacturers). The electronic data sources 120 may aggregate the data and transmit the data (e.g., using APIs) to the analytics server 110a. The analytics server 110a may in turn generate a training dataset using the received data by aggregating data that has been previously masked (e.g., by a processor of the vehicle) and labeling the data. The analytics server 110a may then train one or more AI model(s) 110c using the training dataset. When a new driver associated with the vehicle 140 and end-user device 150 requests an insurance quote, the analytics server 110a may retrieve the driver's data. The analytics server 110a may then execute the trained AI model(s) 110c to generate a preliminary risk of collision (or other events) for the driver and display the risk on the electronic platform accessible via the vehicle computing device 141 and/or end-user device 150. The analytics server 110a may continuously monitor driver and driving session data associated with the vehicle 140 via one or more sensors associated with the vehicle 140. As a result, the analytics server 110a may revise the score using data associated with each driving session associated with the vehicle 140. The analytics server 110a may transmit the revised score to the end-user device 150 and/or the vehicle computing device 141 after each driving session (or only if a driving session causes the score to change).

The analytics server 110a may also transmit the score to a third-party server 180 for further analysis. In a non-limiting example, the third-party server may be associated with an insurance company where the third-party server 180 uses various modeling techniques to generate an insurance premium for the vehicle 140 and its driver.

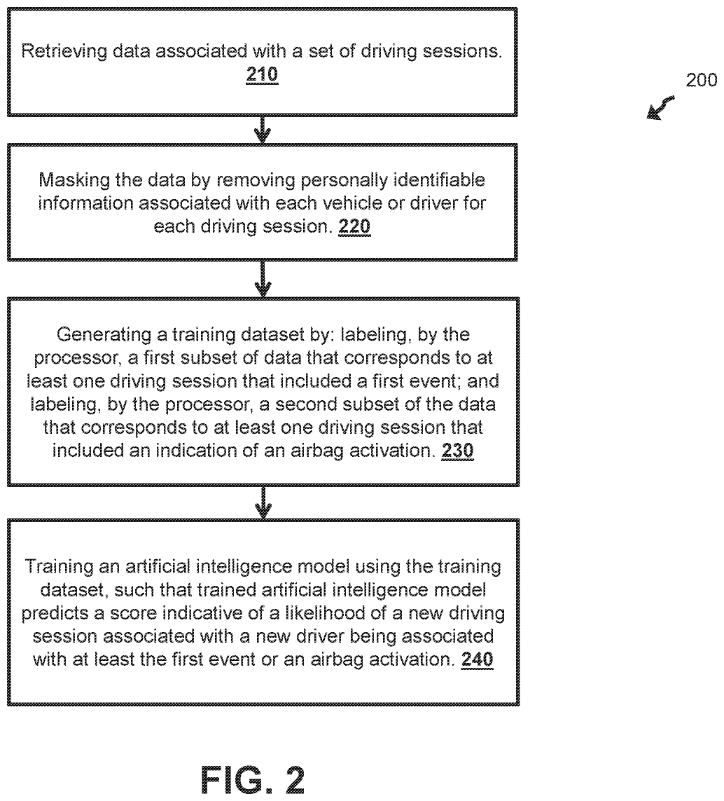

FIG. 2 illustrates a flow diagram of a method 200 executed in an AI-enabled vehicle sensor data analysis system, according to an embodiment. The method 200 may include steps 210-240. However, other embodiments may include additional or alternative steps, or may omit one or more steps altogether. The method 200 is described as being executed by an analytics server (e.g., a computer similar to the analytics server 110a). However, one or more steps of the method 200 may be executed by any number of computing devices operating in the distributed computing system described in FIGS. 1A and 1B (e.g., a processor of the vehicle 140, vehicle computing device 141, and/or the end-user device 150). For instance, one or more computing devices may locally perform part or all of the steps described in FIG. 2 or a cloud device may perform such steps.

At step 210, the analytics server may retrieve data associated with a set of driving sessions. The analytics server may query and retrieve data associated with one or more driving sessions (also referred to herein as driving data) from one or more data repositories. The driving data may correspond to previously completed driving sessions with a known outcome (e.g., whether the driving session lead to a collision). The driving data may include (at least partially) data associated with the driver and/or data collected via one or more vehicle sensors.

Non-limiting examples of driving data may include vehicle miles driven (e.g., odometer reading per trip), days of vehicle usage, peak/average acceleration during a driving session (longitudinal, lateral, and resultant), peak/average speed during a driving session (longitudinal, lateral, and resultant), frequency, intensity, and duration of brake application, requested following distance (e.g., distance to the car in front of the vehicle) when autonomous driving or steering feature is activated, measured and actual following distance when the autonomous driving or steering feature is not activated, lane change indicator usage (per road type), autonomous driving or steering usage on highways, autonomous driving or steering usage off highways, number of autonomous driving or steering hands on wheel warnings, anti-lock braking system (ABS) interactions, automatic emergency brake (AEB) interactions, lane keeping assistant (LKA) data, headlamp usage in different situations (auto, manual, or wet conditions), tire pressure warning, time of day, day of week, average speed, speed vs autonomous driving or steering assumed speed limit, belt usage (compared to occupant detection or belt reminder outputted by the vehicle), audio volume, number of wide open throttle or 100% accelerations, average accelerator position, stability control event frequency, stability control event type (oversteer, understeer, or traction), visibility estimate (rain, dusk, fog, or evening), percentage of difference between road types (highway, sealed, unsealed, multi-lane, single lane), speed in relation to the estimated traffic, and speed in relation to average speed for other vehicles within the area.

Non-limiting examples of driving data may also include whether (and how often) the insured person is driving the vehicle, urban vs. non-urban roads, traffic data associated with the road, residential data associated with the road, road condition or wheel slippage (e.g., concrete vs. dirt, speed bumps, or potholes), regenerative braking, creep speed tracking data, exterior light usage, regenerative braking, steering data, mirror tilt and fold data, parking assistant chimes, state of activation for various features (blind spot collision warning chime, automatic emergency braking, obstacle-aware acceleration, speed limit warning, forward collision warning, or the auto-steering feature), set cruise follow distance, customization setting of autonomous driving or steering features, number/frequency of warning due to the driver not having their hand on the steering wheel, auto park usage vs human parking, parking location (whether private or public), use of security alarm, intrusion/tilt data for the vehicle, passive keyless entry, detection of driver exhaustion, use of turn signals, battery charging pattern, cabin temperature, level of braking fluids, presence in areas that should be avoided, detected events by a security system, and the like.

The driving data may also include other driver interactions with a vehicle that are secondary to actions required to operate the vehicle, such as music volume, interaction with a touchscreen infotainment system, text messages, telephone calls, use of voice commands, interaction with a touchscreen or buttons compared to voice commands or steering wheel controls, and the like.

Depending on various accuracy thresholds, the analytics server may either account for or remove driving data while the driver has activated the autonomous driving or steering feature. In some embodiments, the analytics server may assume that all driving data is associated with the driver (because the driver is still responsible for the vehicle regardless of whether the autonomous driving or steering feature has been turned on or off). The analytics server may determine that the use of the autonomous driving or steering feature is safer and calculate a score representing a lower risk of a collision when using such a feature. Therefore, the model may reward drivers who use these features more frequently. Alternatively, the analytics server may identify whether an autonomous driving or steering feature was activated and remove the driving data while the autonomous driving or steering data was turned on, such that the AI model is only trained based on how the driver (and not the autonomous driving or steering feature) operated the vehicle.

In some embodiments, the analytics server may only account for and include driving data within a grace period that is calculated based on whether the user has activated the autonomous driving or steering feature. For instance, in embodiments where the analytics server does not evaluate/include driving data during a time window where autonomous driving or steering is activated, the analytics server may further exclude (e.g., not evaluate) data for an additional time (e.g., three minutes) before the autonomous driving or steering has been activated and/or after the autonomous driving or steering has been terminated.

Additionally or alternatively, the driving data may include whether an autonomous driving or steering feature was automatically disengaged. The autonomous driving or steering feature may include a monitoring feature where the driver's behavior and the vehicle's conditions are evaluated to determine whether the driver is eligible to continue to use the autonomous driving or steering feature. For instance, the autonomous driving or steering feature may monitor the driver's behavior and may disengage the driver if the driver's behavior satisfies certain criteria, such as not having their hands on the steering wheel or not looking at the road (e.g., distracted drivers who are attending to other devices, such as texting and driving). The analytics server may note that a driver has been disengaged from the autonomous driving or steering feature and may indicate that as a data point included within the training data. As a result, a driver's behavior that caused the autonomous driving feature to be disengaged can also count negatively towards the driver's score.

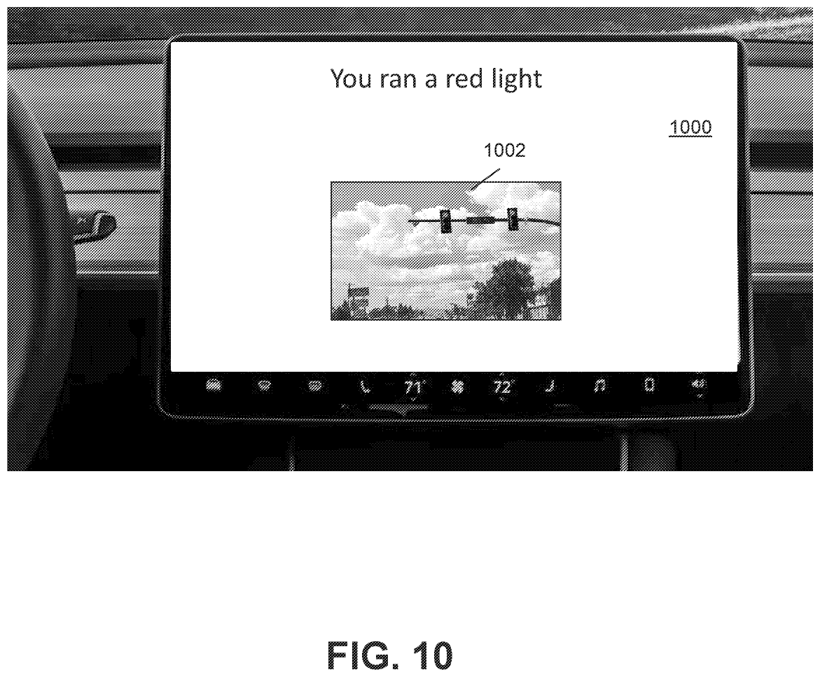

As described herein, the analytics server may also capture data associated with reasons that the driver was disengaged from the autonomous driving/steering feature. For instance, when a driver is disengaged, the analytics server may communicate with an in-cabin camera and obtain an image of the driver. The image may depict the driver being distracted (e.g., texting and driving or the driver looking in a different direction). The analytics server may display the image in conjunction with a description of why the driver's score was lowered, e.g., as depicted in FIG. 10.

Additionally or alternatively, the analytics server may determine the frequency and duration that a driver utilizes the autonomous driving or steering feature and may include that attribute within the training dataset. Moreover, other related attributes may be included, such as time of day, road conditions, and other data associated with when and how the autonomous driving or steering was used.

The analytics server may collect and/or analyze data received from various interior and exterior cameras of each vehicle. Each vehicle may be equipped with driver-facing cameras (sometimes referred to herein as in-cabin cameras as well). The analytics server may collect footage received or recorded by these cameras. The analytics server may execute various content analysis protocols (e.g., a facial recognition, eye gaze analysis, and/or mood analysis) based on the footage to determine various attributes associated with the driver. For instance, the analytics server may determine that the driver was distracted because the driver's eye gaze was not directed towards the road for more than a predetermined threshold (e.g., more than five seconds or any other threshold indicated by a system administrator). In another example, the analytics server may determine that the user was operating a mobile device (e.g., texting and driving) by detecting a mobile device in the driver's hand and determining that the driver's eye gaze was focused towards the mobile device. The analytics server may also determine the frequency and duration of the driver using their phone throughout a driving session.

In another example, the analytics server may collect and aggregate footage recorded by one or more exterior-facing cameras of the vehicle. The analytics server may then execute various analytical protocols to determine attributes of the environment surrounding the vehicle while being driven. In one example, the analytics server may determine driving attributes based on the vehicle's proximity to other vehicles. For instance, the analytics server may determine that the driver's lane-changing skills are less than ideal because other vehicles were closer than a predetermined threshold when the driver changed lanes. Additionally, the analytics server may also collect various metrics and data collected that are associated with at least one sensor of the vehicle, such as the forward collision sensor. In other configurations, data collected by the camera can be analyzed to determine and generate forward collision warnings.

In another example, the analytics server may determine whether the driver disobeyed any traffic laws. Using the footage, the analytics server may determine the content of various traffic signs during a driving session. The analytics may then determine whether the vehicle was driven in a manner that was consistent with the traffic signs. For instance, using the camera feed, the analytics server may determine that a driver has ignored a stop sign because the analytics server determines the existence of a stop sign and determines that when the vehicle reached the stop sign, the vehicle did not come to a full stop. This data can also be enriched using other location and traffic-specific data. For instance, the analytics server may determine traffic signs/laws by querying a database using a location of the vehicle.

In another example, the analytics server may analyze the footage to determine driving conditions and use this data to determine a correlation (if any) between an event/collision and the driver/driving session. For instance, the analytics server may use various analytical protocols to determine weather or road conditions (e.g., snow or ice on the ground). This data may be indicative of a risk of collision. For instance, a driver who drives in worse conditions more frequently may be at a higher risk of collision.

In another example, the analytics server may determine a risk factor associated with the geographic location associated with the driving session. Using GPS data and/or camera data, the analytics server may determine whether the driving session is taking place at a geographical location (e.g., neighborhood or zip code) that indicates a likelihood of collision or other events that is higher or lower than other geographical areas. For instance, the analytics server may determine that a driving session is associated with a neighborhood with a higher likelihood of theft or collision.

The analytics server may analyze the data to determine non-driving data associated with the vehicle. For instance, the analytics server may use the interior-facing camera feed to determine how many people are present within the vehicle during a driving session. The analytics server may apply a threshold to the infotainment system volume to determine that music was being played at an excessive volume above the threshold during the driving session.

Additionally or alternatively, the analytics server may execute a facial recognition protocol to determine who is driving the vehicle. If the vehicle is being driven by anyone else other than the driver (the person known to be the primary driver of the vehicle), the analytics server may not use the data by not including it within the training dataset. If possible, the analytics server may also retrieve data associated with a key (or an application) used to start the vehicle to identify the driver.

The analytics server may also analyze driving data received from the vehicle to determine data associated with the surface/pavement. For instance, the analytics server may analyze how wheels react when the driver is braking or making a turn, such as the slippage of the wheels and loss of traction. By including this data within the training dataset, the AI model may uncover a correlation between pavement data and a risk of collision.

When one or more sensors within the vehicle identify a collision or a predetermined event (e.g., airbag activation), the analytics server may retrieve camera feeds from one or more cameras in communication with the vehicle. The analytics server may limit the video feed to a predetermined time threshold before and after the collision (e.g., five minutes before and after the collision). The analytics server may analyze the captured video feed to determine the conditions of the collision (e.g., how the other vehicle involved in the collision was driving and who was legally at fault). The analytics server may present the video feed on a platform where a human reviewer can review the data. The reviewer can label the driving session and identify whether the driver was at fault. For instance, the human reviewer can indicate that the driver inappropriately changed lanes without using turn signals.

The analytics server may also monitor other electronic devices in communication with the vehicle, such as mobile devices that are in synchronized communication with the vehicle's infotainment system. As a result, the analytics server may determine the frequency and duration of use during a driving session. For instance, a driver may be using their mobile device while a hands-free mode is activated for more than half of the driving session. In another example, the analytics server may determine that the driver was using a mobile device to interact with the vehicle's infotainment system (e.g., play music in the vehicle by selecting the music from the mobile device).

The analytics server may also determine the frequency and duration of the infotainment system usage (e.g., the touchscreen of the vehicle). The analytics server may retrieve data indicative of whether the driver was operating the touchscreen (as opposed to using other input elements, such as the steering wheel or using voice command) while driving. The analytics server may analyze the video feed (or other vehicle occupancy data) to determine who was interacting with the touchscreen.

The analytics server may collect, analyze, and aggregate the driving data received. As will be described below, the analytics server may process the aggregated data to generate a training dataset and train an AI model accordingly.

At step 220, the analytics server may mask the data by removing personally identifiable information associated with each vehicle or driver for each driving session. By masking the data, the analytics server may train the AI model without violating the driver's privacy or using any vehicle's identifying information. In this way, the AI model may be trained using pertinent data without identifying each individual driver's driving behavior and characteristics. As described herein, the data may be masked using a processor of the vehicle, such that the data does not include any PII when received by the analytics server. Additionally or alternatively, the data may be masked using the analytics server itself. In yet another configuration, the data may be partially masked by the vehicle and partially masked by the analytics server.

The analytics server and/or a processor of the vehicle may mask the aggregated data by removing personally identifiable information from the driving session data, such as name or other identifying information associated with the driver or any identifying data associated with the vehicle (e.g., VIN number). The vehicle may transmit data using a randomly-generated pseudonymous identifier that is a unique identifier for the vehicle and/or the driver to the analytics server. The unique identifier may act as a pseudonym for the vehicle and/or the driver, such that the AI model can correlate the corresponding data and identify all driving session data associated with a vehicle and/or driver by just using the pseudonym. For instance, the AI model may analyze the data in its entirety, such that different driving sessions for the same vehicle and/or driver are identified.

At step 230, the analytics server may generate a training dataset by labeling a first subset of data that corresponds to at least one driving session that included a first event; and labeling, by the processor, a second subset of the data that corresponds to at least one driving session that included an indication of an airbag activation.

The analytics may label the data, such that each driving session is associated (or expressly not associated) with a predetermined event, such as a collision event (e.g., airbag activation, crash detection by any sensors associated with the vehicle, and/or an insurance claim associated with the driving session's timestamp). In an example, the analytics server may retrieve data associated with insurance claims filed. Using the driver and/or vehicle's identification data (e.g., name or VIN number or a pseudonym generated), the analytics server may identify all data corresponding to the vehicle and/or driver. Using a timestamp of the collision (retrieved from an insurance claim), the analytics server may identify driving data corresponding to the driving session that included the collision. The analytics server may then label the driving data associated with the collision and include the labeled data within the training dataset as ground truth.

In another example, the analytics server may also determine if driving data associated with a particular driving session indicates an event (e.g., activation of an airbag). Using this data, the analytics server may then label the driving data as associated with the event.

The analytics server may use human reviewers to label various data attributes. For instance, as discussed above, the driving data may also include video feed received from one or more cameras of a vehicle. The analytics server may display the video feed on an electronic platform where the labeling can be performed by a human reviewer. For instance, a human reviewer can determine whether the collision was the driver's fault by reviewing video associated with a collision.

After labeling, the training dataset may include at least three categories of labeled data. First, the training dataset may include all driving sessions (and their corresponding driving data) that included an insurance claim. Second, the training dataset may include all driving sessions (and their corresponding driving data) that included a predetermine event (e.g., airbag activation or a sensor identifying a collision). Third, the training dataset may include all driving sessions (and their corresponding driving data) that did not include an insurance claim or the event.

At step 240, the analytics server may train an AI model using the training dataset, such that the trained AI model predicts a score indicative of a likelihood of a new driving session associated with a new driver being associated with at least the first event or an airbag activation.

The AI model may be trained based on previous driver and driving session data included within the training dataset. For instance, the analytics server may train the AI model using driving data associated with driving sessions that are known and labeled to have resulted in an accident or an event. The analytics server may train the AI model using a supervised method where the driver and driving session data are fully labeled, as discussed above. For instance, the training dataset may be labeled, such that the AI model can predict whether a driving session or a driver (based on their attributes) would lead to an event, such as an accident, an airbag activation, and the like. Using various artificial intelligence training techniques, the AI model may identify hidden patterns within the training dataset, such that the AI model can predict new scores given a new set of driver and/or driving session data.

Additionally or alternatively, the analytics server may use an unsupervised method where the training dataset is not labeled. Because labeling the data within the training dataset may be time-consuming and may require high computing power, the analytics server may utilize unsupervised training techniques to train the AI model.

The AI model may be trained using one or more labeled training datasets for supervised training. For example, the analytics server may use a curated training dataset comprising a chronological series of driving data leading towards an event/collision. Each chronological series of data may be labeled with a ground truth value or feature vector indicating a ground truth state. The analytics server may feed the series of data to the AI model and obtain an output predicted data object indicating a predicted score. The analytics server may compare the predicted score with the ground truth data to determine a difference and train the AI model by adjusting the AI model's internal weights and parameters proportional to the determined difference according to a loss function. The analytics server may train the AI model in a similar manner until the trained AI model's prediction is accurate to a threshold (e.g., recall or precision). Upon determining the AI model is accurate to the threshold, the analytics server may implement the trained AI model to predict scores for new vehicles. The analytics server may continue to train the machine learning model using data that is generated based on various other vehicles and drivers.

Additionally, the data analytics server may continuously train the AI model based on periodic monitoring of vehicle and driver data associated with the new driver. The analytics server may also continuously and iteratively train the AI model based on administrator and/or end-user interactions and feedback. The analytics server may monitor various user interactions with the predicted data to improve the results by revising and retraining the AI model. The analytics server may monitor the electronic device viewing the predicted results to identify whether the predicted results are accepted or rejected and/or revised. The analytics server may then revise and retrain the AI model accordingly.

For instance, when an administrator reviews the results predicted by the AI model, the analytics server may determine how the administrator interacted with the predicted results by editing, deleting, accepting, or revising the results. Using this monitored data, the analytics server may then retrain the model to improve its accuracy. The analytics server may utilize an application-programming interface (API) to monitor the administrator's activities. The analytics server may use an executable file to monitor the user's electronic device. The analytics server may also monitor the GUIs displayed via a browser extension executing on the electronic device. The analytics server may monitor multiple electronic devices and various applications executing on the electronic devices. The analytics server may communicate with various electronic devices and monitor the communications between the electronic devices and the various servers executing applications on the electronic devices.

Additionally or alternatively, the analytics server may display a prompt requesting feedback from a user viewing the predicted results. The analytics server may then recalibrate the AI model accordingly. For instance, the analytics server may use one or more of the following machine-learning approaches to train the AI model: regression, classification, clustering, dimensionality reduction, ensemble methods, neural nets and deep learning, transfer learning, reinforcement learning, and the like.

The AI model may be any machine learning model (e.g., a neural network, a random forest, LSTM, a support vector machine, etc.) that is configured to generate a data object indicating a predicted likelihood of an event, such as collision or any other predetermined event (e.g., airbag activation). The analytics server may execute the AI model by generating a feature vector representing a new driver and/or driving data associated with the new driver. The analytics server may apply the feature vector to the trained AI model. As a result, the trained AI model may generate a score for the new driver and/or the vehicle.

To generate the feature vector based on the driver and vehicle data, the analytics server may generate a feature vector with values that represent each data point within a dataset that includes all data associated with the new vehicle/driver. In some cases, the analytics server may normalize the input values to values between −1 and 1 or 0 and 1 to obtain more accurate results as the trained AI model processes the feature vector.

Using the feature vector, the analytics server may execute the trained AI model to receive a predicted score. After receiving the predicted score from the AI model, the analytics server may display the predicted results onto an electronic device, such as an electronic device operated by an administrator. Additionally or alternatively, the analytics server may display the predicted results on an electronic device associated with the new vehicle and/or driver, such as on the vehicle computing device 141 and/or end user device 150 depicted in FIG. 1A. For instance, a driver may login a website (or access a mobile application) to view the score for various driving sessions. The analytics server may also display other driving data (e.g., speed, video feed, or other data received from one or more sensors in communication with the vehicle). For instance, the analytics server may display forward collision information (e.g., how many times the driver was at risk of forward collision). The analytics server may also display various analytical metrics. For instance, the analytics server may calculate and display various score trends over time, such that the driver can determine whether the score is increasing or decreasing overall.

Additionally or alternatively, the analytics server may transmit the predicted results to a downstream software application or another server. The predicted results may be further analyzed and used in various models and/or algorithms to generate an insurance premium for the vehicle and/or the driver (e.g., third-party server 180 depicted in FIG. 1A). The analytics server may also display the insurance data and whether the driver's actions (during a particular driving session) has caused the insurance quote to increase or decrease. For instance, after completing a trip, a driver may logon to a website or an application to determine whether the trip has caused the driver's insurance premium to increase or decrease. The analytics server may display a new premium and may identify a reason why the premium was raised (e.g., your insurance premium was raised to $100 a month because your vehicle was at a high risk of collision five times within your last trip).

Additionally or alternatively, the analytics server may detect vehicle modifications when applicable. A non-limiting example of a vehicle modification may include damaging or obstructing any sensor, such that the sensors do not properly monitor driving data. For instance, a driver may obstruct a sensor of the vehicle, such that the sensor cannot accurately identify a risk of forward collision. The analytics server may transmit a notification to an insurance company (or any third-party server) that at least one inappropriate modification has been identified. The insurance company may use this information as an input to insurance policy rules or a fraud detection system. In some embodiments, the AI model may also account for the modifications to determine the score for the driver and/or the driving session.

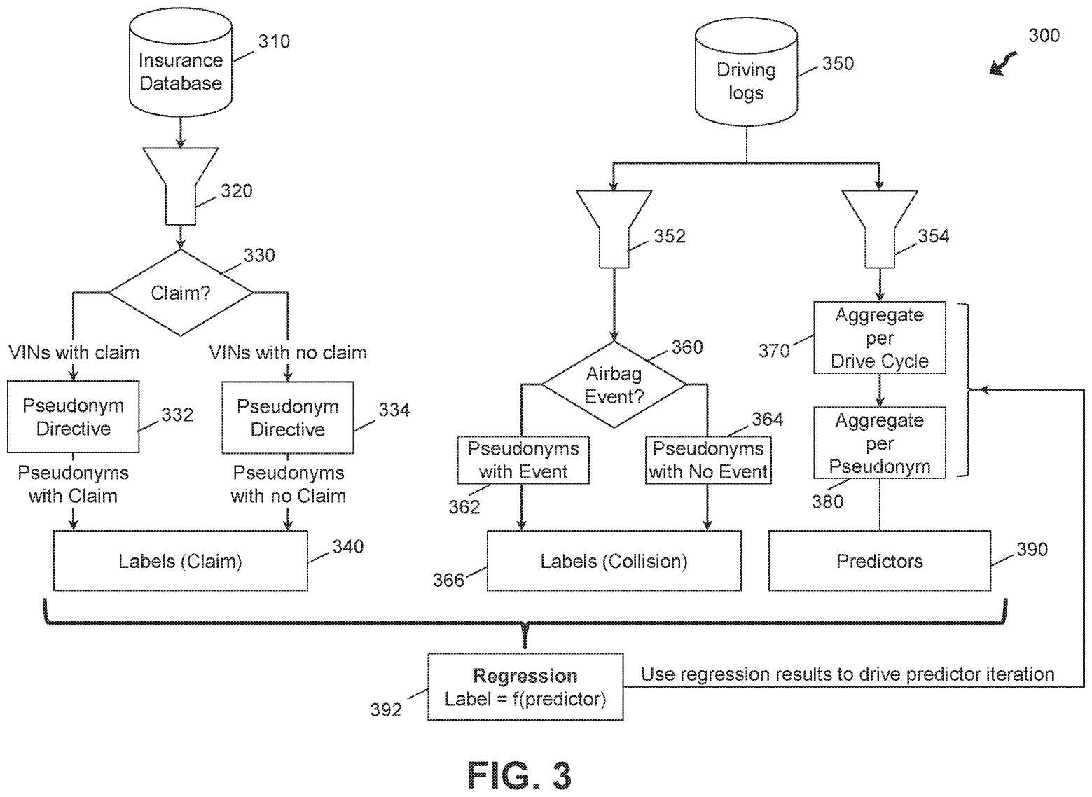

Referring now to FIG. 3, a non-limiting example of training the AI model is presented. The method 300 depicts training the AI model discussed herein using a supervised method (e.g., step 392). The data used to train the AI model may be retrieved using two separate processes. Various parts of each process can be combined into a single process. Moreover, different steps can be added, removed, and/or modified. Therefore, the method 300 is not limiting to the training methods discussed herein.

The analytics server may use two separate sources because sensor data may not always align with insurance claim data. For instance, a collision registered by one or more sensors may not always lead to an insurance claim. Some collisions may not be severe enough (e.g., scratched bumper or colliding with an immobile object such as a garage door) for the driver to claim the collision as an accident through their insurance policy. In another example, the vehicle's insurance pricing structure may force the driver not to submit a collision claim for certain collisions. Therefore, training the AI model solely based on insurance data may not allow the AI model to realistically predict a likelihood of collision for the driver and/or the vehicle. Accordingly, the analytics server may generate two separate training datasets from two different sources.

To generate the first training dataset, at step 310, the analytics server may access a database (e.g., insurance database) to retrieve data associated with previously recorded driving sessions, driver, and/or vehicle data. The insurance database may include driver data, driving session data, and vehicle data for previous and current customers. The insurance database may also include claim data associated with each driving session (if applicable). For instance, when a driver files an insurance claim (e.g., after an accident), an insurance server (not shown) may collect driving session data and claim data. The server may then store the data associated with the collision within the insurance database. The server may also store driving data associated with driving sessions that did not lead to an insurance claim. Therefore, the insurance database may include driving session data associated with claims and driving session data not associated with claims. Accordingly, this data can be used to differentiate between driving sessions that lead to an insurance claim from other driving session data.

In some configurations, the insurance database may only include driving data that correspond to an insurance claim. The analytics server may retrieve driving session and vehicle data from another data source (e.g., driving log database). In some configurations, the insurance database may only include claim data and not include any driving data.

At step 320, the analytics server may retrieve driving session data and may aggregate all data associated with different driving sessions. If necessary, the analytics server may segment the data, such that the AI model's training is customized. For instance, the analytics server may filter driving sessions that occur within a geographic location (e.g., Dallas, TX). The analytics server may then use the filtered data to train the AI model. As a result, the AI model may be trained to analyze and score driving sessions in Dallas, TX.

At step 330, the analytics server may query each driving session to identify whether each driving session was associated with an insurance claim. As a result, the analytics server may bifurcate the data into two groups. The first group may include driving session data associated with vehicles (VINs) and at least one insurance claim. The second group may include driving session data associated with vehicles (VINs) and no insurance claim.

At steps 332 and 334, the analytics server may execute a pseudonym directive protocol to anonymize data associated with all the driving sessions. As described herein, the vehicle may transmit data using a randomly-generated pseudonymous identifier that is unique to the vehicle, but is not associated with personally identifiable data associated with the driver and/or the vehicle such as address, name, insurance policy number, and the like. The vehicle may then execute a pseudonym directive protocol to request pseudonyms associated with a group of VINs for each categorical label in the training dataset. The same pseudonym will identify all data associated with the same vehicle, driver, and/or driving session. As a result, the analytics server is able to aggregate labeled data associated with the same vehicle without feeding any personally identifiable information (e.g., VIN) to the AI model. As described herein, in some embodiments, the analytics server may at least partially mask the data.

After executing the pseudonym directive protocol, the analytics server may generate a training dataset (step 340) by labeling the data as discussed above. Specifically, the analytics server may label whether each driving session (and its corresponding driving data and/or driver data) corresponds to an insurance claim.

To generate the second training dataset, at step 350, the analytics server may retrieve driving session data from a database that stores driving logs and sensor data. The analytics server may bifurcate the data and use various filtering or segmentation discussed herein at steps 352 and 354. The first set of data may be analyzed at step 360. Specifically, the analytics server may determine whether there was an event associated with each driving session. As discussed herein, an event may include any event detectable using sensor data that may indicate a collision or risky driving behavior. An example of an event may be an airbag activation or any impact sensed by any of the sensors associated with the vehicle. In the depicted embodiment, the event refers to an airbag activation. However, this example is not limiting to how the analytics server trains the AI model.

The analytics server may also anonymize the data using pseudonym directive protocols discussed in steps 332 and 334. As a result, the analytics server may use pseudonym driving sessions that included the event and pseudonym driving sessions that did not include the event. The analytics server may then label each driving session accordingly at step 366.

In order to generate smaller datasets, the analytics server may aggregate driving session data for defined periods of time or drive cycles. For instance, the analytics server may retrieve the data associated with all driving sessions that preceded an event within a predetermined time period (steps 370 and 380). When the analytics server identifies an airbag event associated with a vehicle, the analytics server may aggregate driving session data associated with the same vehicle for the past month (e.g. driving data associated with each trip taken by the driver in the preceding month or any other time period defined by a system administrator). In this way, when a driver is associated with an airbag event, the analytics server aggregates driving data for the previous month to train the AI model, such that the AI model can analyze other driving sessions to uncover which driving characteristics led to the event. Using this approach, the analytics server trains the AI model to analyze data other than the specific driving session that led to the event.

The analytics server may use connectivity data to aggregate driving session data within a drive cycle. As described herein, a drive cycle may refer to a time window analyzed by the analytics server to generate a score. The duration of the drive cycle may be any predetermined amount of time that is revisable by a system administrator. For instance, when the drive cycle is set to be thirty days, the analytics server aggregates and analyzes driving session data for the past thirty active days to calculate a score indicative of a likelihood of an event for the vehicle and/or the driver.

In order to accurately analyze the likelihood of an event, the analytics server may limit the data included within the drive cycle to days that the vehicle was connected to a network (or active). The analytics server may differentiate between days for which no driving session data has been received. Using an independent stream of data, the analytics server may verify whether the vehicle was properly connected to a network and able to transmit drive data to the analytics server. If the analytics server determines that the vehicle was connected and no drive data was transmitted, the analytics server assumes that the vehicle was not driven that day and includes the data within the drive cycle (e.g., include an indicator that the vehicle was not being driven that day). However, if the analytics server determines that the vehicle was not connected to a network for a period of time, the analytics server may not include that period of time within the drive cycle. As a result, the analytics server may adjust the drive cycle range to include driving session data for other days.

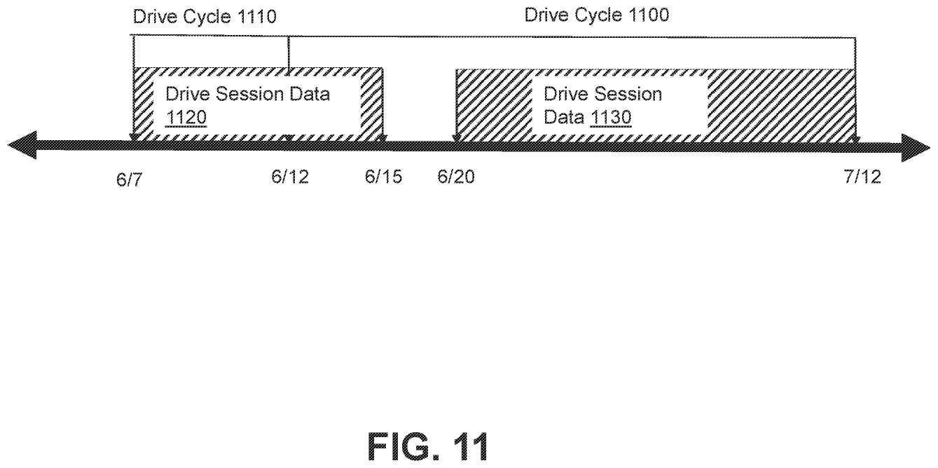

Referring now to FIG. 11, an example of adjusting a drive cycle range is depicted. The analytics server may receive driving session data from a vehicle on July 12^{th}. As a result, when calculating the score for the driver, the analytics server analyzes the driving session data for the previous thirty days (e.g., drive cycle 1100 that includes data from June 12^{th} to July 12^{th}). The thirty-day drive cycle may be revised by a system administrator. For instance, for some drivers, the analytics server may analyze driving session data within the past sixty days to calculate a score.

If the analytics server determines that the vehicle did not have proper connectivity from June 15^{th} to June 20^{th} during the drive cycle, the analytics server may add five preceding days (drive cycle 1110) for a revised drive cycle containing driving session data 1120, 1130. Therefore, the driver's score on July 12^{th} may include driving data that is outside the thirty-day drive cycle threshold.

Referring back to FIG. 3, the analytics server may store the drivers' aggregated data for the previous drive cycle as predictors (step 390). As used herein, predictors correspond to data that could predict a labeled event. For instance, in the depicted embodiment, the analytics server may train the AI model to analyze the predictors generated at step 390 (e.g., driving session data for the month preceding the event) to identify patterns indicating a high likelihood of the event occurring again.

When aggregating driving data for different driving sessions, the analytics server may perform various standard AI pre-processing protocols (e.g., quantile transformation protocols) and down-sampling, such that the AI model uses normalized data that is distributed within known and appropriate ranges. Transforming the data may help the AI model achieve better result while reducing training time and increasing training efficiency.

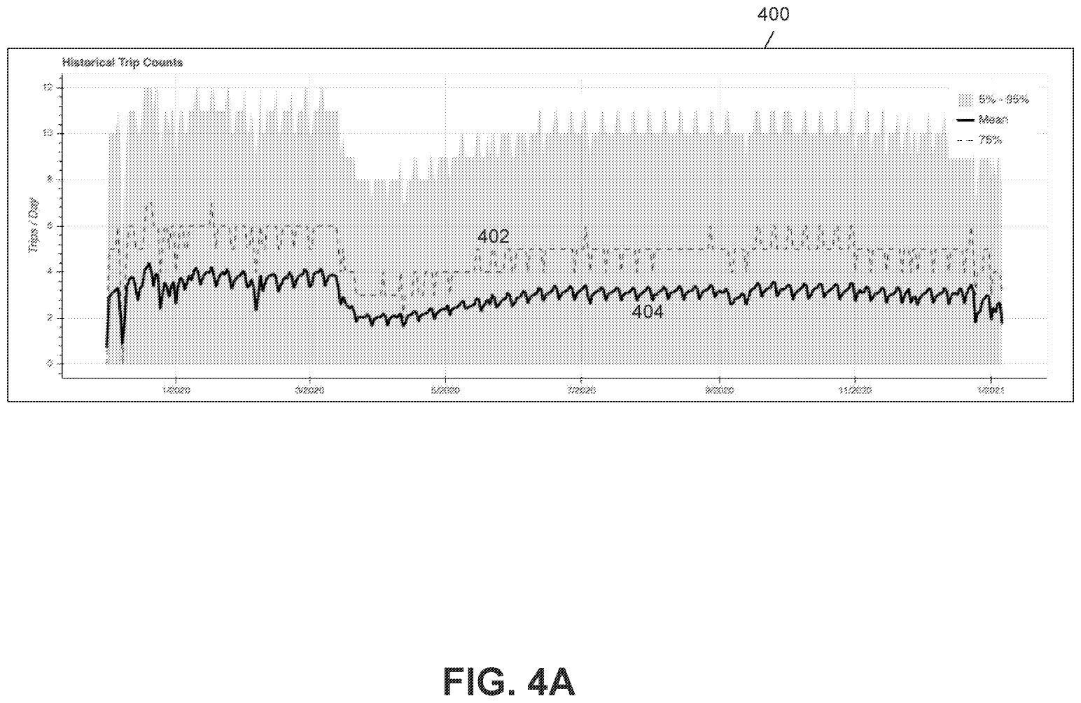

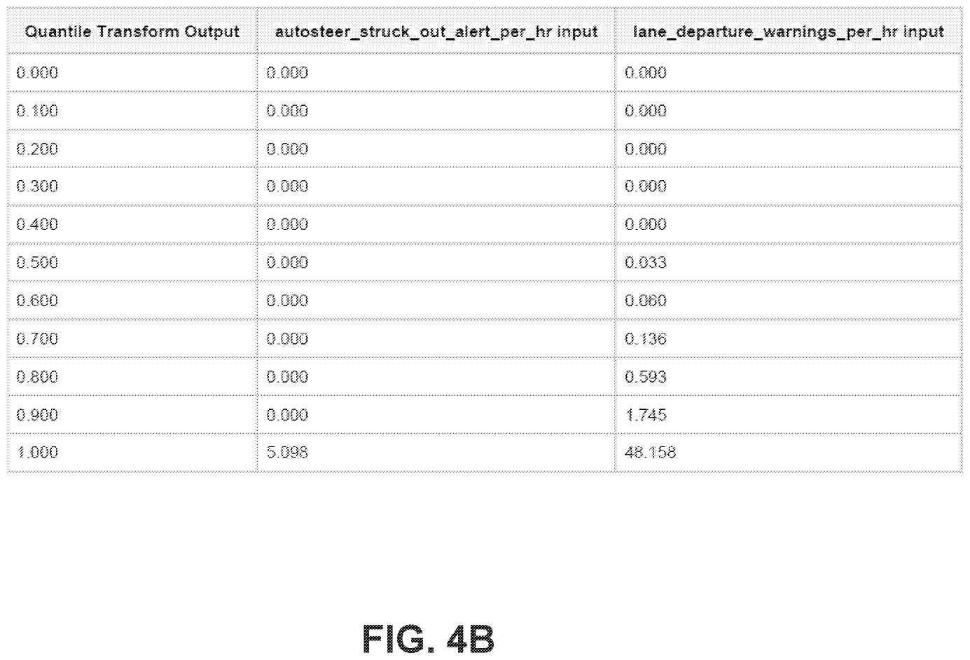

As depicted in FIG. 4A, the analytics server may reduce the volume of driving sessions retrieved. On an average day, the analytics server may receive driving data associated with more than 50,000 vehicles and their corresponding driving session data. As depicted in chart 400, the analytics server may identify and exclude outlier data (outside the range of 5%-95%) to reduce the volume of data. In another example, the analytics server may only use a mean number of trips per day and the corresponding data (represented by line 404) or a 75% percentile of trips per day and the corresponding data (represented by line 402) by including data associated with fewer driving sessions within the training dataset.

In another example, the analytics server may also down-sample sensor data. The analytics server may receive numerous readings from a vehicle sensor. However, the analytics server may alter the frequency of the reading by transmitting a signal to one or more sensors. In another example, the analytics server may average the data or only include less frequent data within the training dataset. For instance, when a sensor's reading frequency is set to one reading every five seconds, the analytics server may decrease the frequency by instructing the sensor to only transmit one reading every 1 minute. In another example, the analytics server may average readings for each minute and include the average data within the training dataset. Effectively, the analytics server may include one reading for every 12 readings received from a sensor within the training dataset.

In another example, the analytics server may only include certain data within the training dataset if various thresholds are satisfied. For instance, the analytics server may only include headway data within the training dataset when the vehicle's speed is above 80 mph (or any other defined threshold).

In another example, the analytics server may transform certain data received from sensors to a uniform distribution over the range [0, 1] using a quantile transformation protocol to linearly map values to a uniform distribution (e.g., Quantile (0.1, X)=5 and Quantile (0.2, X)=10, the transformation ‘f’ would return f (7.5)=0.15).

Certain data categories (e.g., lane departure data) may have non-normal distributions. For instance, not many drivers may receive an autonomous driving or steering strike out (e.g., when a sensor determines that the driver is distracted and can no longer use (is disqualified or disengaged from use of) the auto-steering feature). The autonomous driving or steering strike-out feature may be so rare that the 95^{th} percentile value of autonomous driving or steering strikeouts per hour may be close to zero for most drivers. This data distribution may not be statistically significant enough to meaningfully train the AI model. As a result, the analytics server may utilize a defined analog range in the auto-steer struck out events. Specifically, the analytics server may re-scale values between 0.9 and 1 to fit between 0 and 1, as illustrated by pre-processing depicted in FIG. 4B. In this way, each driving session may include a 0 autonomous driving or steering strikeouts. Moreover, if the driving session is within the range area of 0.9 and 1, the analytics server may linearly interpolate a new value between 0 and 5 and rescale the autonomous driving or steering strike-out value to fit between 0 and 1 appropriately. That is, the analytics server may apply a numeric transformation that buckets values received from one or more sensors based on the value's relation to overall population and re-uniformly distributes that data across the full range of 0 and 1.

In an example, the analytics server may perform the following transformation to transform values at the edges or outside of the training range: if adjacent quantile thresholds have the same value (e.g., if there are many ‘0’ values), the lowest appropriate quantile threshold is used as the output; input data above the range of defined thresholds is set to 1; and input data below the range of defined thresholds is set to 0.

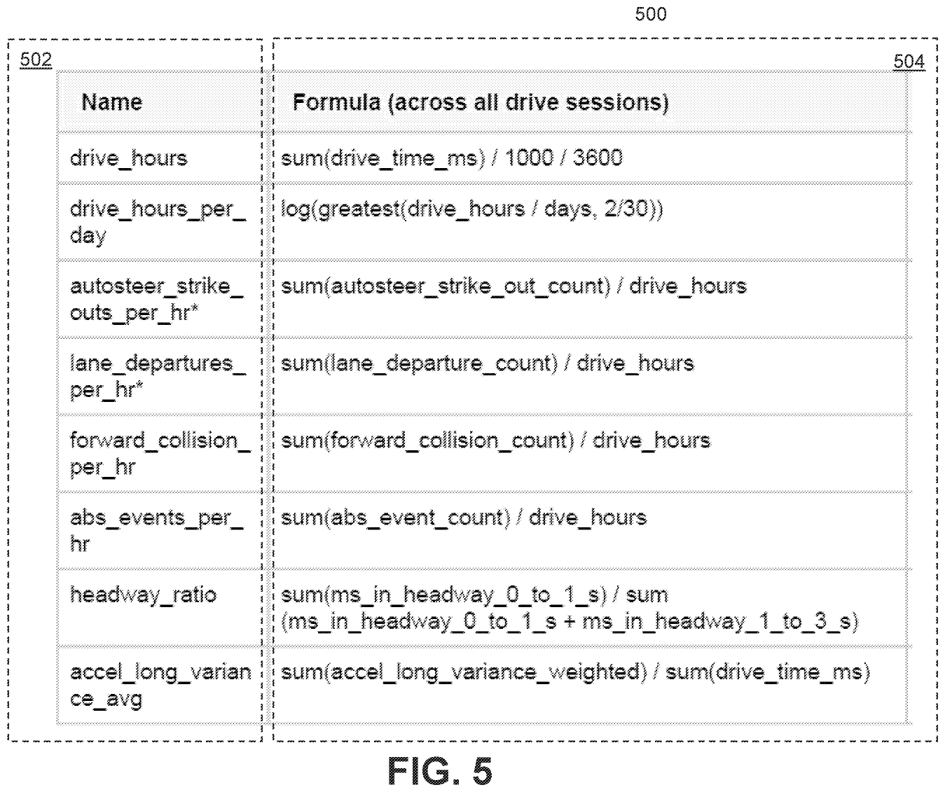

Referring back to FIG. 3, at step 392, the analytics server may train the AI model using the labeled data and predictors discussed herein. The analytics server may use a supervised training method to train the AI model. However, in some other embodiments, the analytics server may use a semi-supervised, unsupervised, or reinforcement learning method to train the AI model. During training, the AI model may determine which factors are more likely to indicate a risk of collision or an event. For instance, as depicted in chart 500 (FIG. 5), the AI model determines that factors 502 are highly indicative of whether a driving session has a high risk of collision or an event.

The above-described factors may depend on vehicle type and/or location of the vehicles. For instance, some vehicles may not be equipped with autonomous driving hardware and sensors. In those embodiments, the analytics server may use different factors to accommodate local state or country regulations or may use different data collected from the vehicle. The analytics server may use the vehicle software version to determine model type and to determine data associated with the vehicle (e.g., whether the vehicle is equipped with sensors needed to collect the desired data).

The analytics server may not consider personal factors (e.g., driver's age or gender). Instead, the analytics server may focus on behavioral and environmental differences.

Specifically, the AI model determines that overall drive hours, drive hours per day, autonomous driving, or steering strike out (e.g., when the driver has activated the auto steer feature but the vehicle has sensed that the driver did not have their hand on the steering wheel), lane departure, forward collision, ABS brake instances, headway ratio, and acceleration are most relevant data to be analyzed when calculating a score for the driver and/or driving session. When trained, the AI model may determine a weight associated with each of the above-described factors and may generate the score accordingly.

As discussed herein, the analytics server may perform standard AI pre-processing (e.g., quantile transformation protocols) on raw data received from the sensors to create uniform driving data for all vehicles and drivers. For instance, the AI model may perform standard AI pre-processing, such as the quantile transformation protocols 504 for each factor 502.

In one example, a driver requests an insurance premium quote using a platform provided by the analytics server. Upon receiving proper authorization, the analytics server identifies the driver's vehicle (using an identifier, such as VIN). The analytics server monitors sensor data collected by one or more sensors of the driver's vehicle for a predetermined amount of time (e.g., a month or a predetermined number of driving sessions). The analytics server pre-processes the driving data received from the sensors and generates a feature vector for the driver. The AI model is trained using driving data associated with previous driving sessions. The analytics server then executes the AI model to generate a score for the driver based on the collected data.

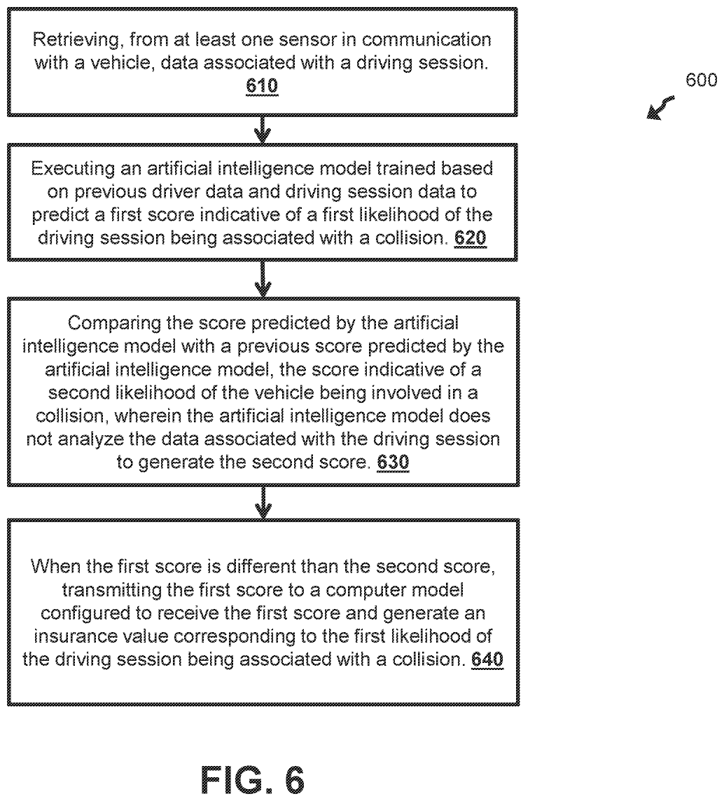

Referring now to FIG. 6, the method 600 illustrates a flow diagram executed in an AI-enabled vehicle sensor data analysis system, according to an embodiment. The method 600 may include steps 610-640. However, other embodiments may include additional or alternative steps, or may omit one or more steps altogether. The method 600 is described as being executed by an analytics server (e.g., a computer similar to the analytics server 110a described in FIG. 1A). However, one or more steps of method 600 may be executed by any number of computing devices operating in the distributed computing system described in FIGS. 1A and 1B. For instance, one or more computing devices (e.g., a processor of the vehicle 140 and/or the end-user device 150) may locally perform part or all of the steps described in FIG. 6 or a cloud device may perform such steps.

At step 610, the analytics server may retrieve, from at least one sensor in communication with a vehicle, data associated with a driving session. As discussed herein, the analytics server may retrieve various driving data associated with one or more driving sessions. The analytics server may be in real-time or near real-time communication with the sensors and/or a processor of a vehicle where driving data may be transmitted to the analytics server. In some embodiments, where network connectivity limits the connection between the vehicle and the analytics server, a data repository of the vehicle may aggregate and store the data and transmit the stored data in a batch when network connectivity is re-established. For instance, when the vehicle is at a location without network connectivity, a processor of the vehicle may aggregate the data and transmit the collected data to the analytics server when the vehicle has network connectivity again (e.g., when the vehicle is parked at the driver's garage). During the period without network connectivity, the score may remain unchanged until the new data is collected and processed.

The analytics server may pre-process and transform various data points within the received dataset (collected sensor data), as discussed herein. For instance, the analytics server may reduce data volume or perform various standard AI pre-processing protocols (e.g., quantile transformation protocols) discussed herein.

At step 620, the analytics server may execute an AI model using data associated with a latest driving session to predict a first score indicative of a first likelihood of the latest driving session being associated with a collision, where the artificial intelligence model is trained based on historical driver data and historical driving session data. The analytics server may execute the AI model that is trained using the methods and systems described herein (e.g., FIGS. 2-5). As a result, the AI model may predict a score based on the last driving session (e.g., data collected and aggregated at step 610). The score may indicate a likelihood of the driving session being associated with a collision (or any other defined event). For instance, the analytics server may use driving data collected from various vehicle sensors discussed herein.

At step 630, the analytics server may compare the score predicted by the AI model (step 620) with a previous score predicted by the AI model, the score indicative of a second likelihood of the vehicle being involved in a collision based on historical driving session data of the driver. The analytics server may compare the score associated with the latest driving session against an overall score for the vehicle and/or the driver previously calculated based on the driver's previous driving cycle data. To calculate the overall score for the vehicle and/or the driver, the analytics server may create an average rolling score for the previous ten (or any other number defined by a system administrator) driving sessions. In another example, the analytics server may compare the score for the latest driving session with the previous driving session.

At step 640, the analytics server may, when the first score is different from the second score, transmit the first score to a computer model configured to receive the first score and generate an insurance value corresponding to the first likelihood of the latest driving session being associated with a collision. If the score for the latest driving session is different than the overall score for the driver and/or the vehicle, the analytics server may transmit the score for the latest driving session to a third-party server. The third-party server may be a server associated with an insurance company where the third-party server can analyze the score to calculate an insurance premium.

The analytics server may perform the functionality discussed with regard to the third-party server as well. For instance, the analytics server may also execute various protocols needed to calculate a new insurance premium for the vehicle and/or driver. For instance, the analytics server may execute a second model (algorithmic or artificial intelligence) to calculate the insurance premium. In some configurations, the trained AI model described herein may generate the insurance premium.

Additionally or alternatively, the analytics server may display a prompt on one or more electronic devices (e.g., the vehicle's infotainment system or a push notification outputted via a mobile application onto the driver's mobile phone). For instance, after the analytics server determines that the driving session has ended, the analytics server may calculate a score for the driving session and display the results within the defined time period (e.g., within a minute after the driving session has ended).

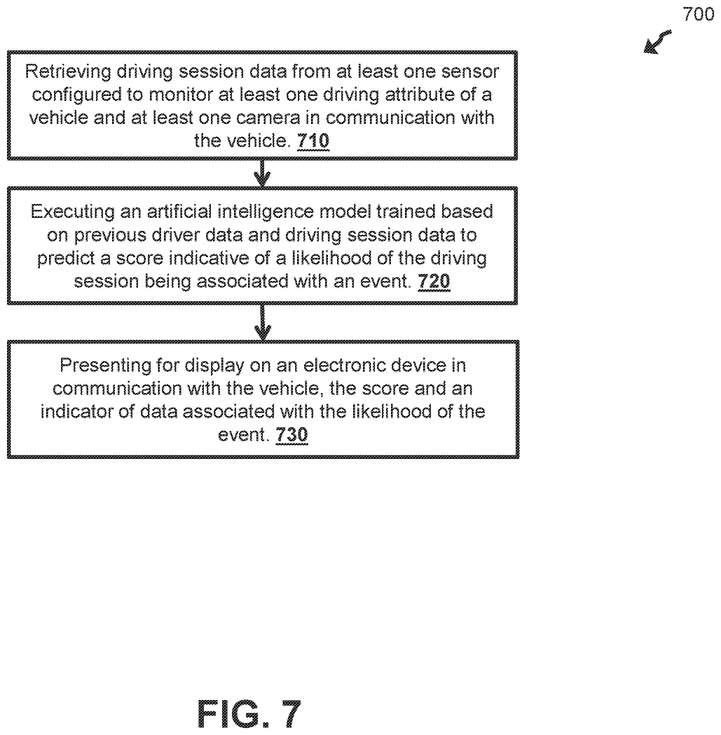

Referring now to FIG. 7, the method 700 illustrates a flow diagram executed in an AI-enabled vehicle sensor data analysis system, according to an embodiment. The method 700 may include steps 710-730. However, other embodiments may include additional or alternative steps, or may omit one or more steps altogether. The method 700 is described as being executed by an analytics server (e.g., a computer similar to the analytics server 110a described in FIG. 1A). However, one or more steps of method 700 may be executed by any number of computing devices operating in the distributed computing system described in FIG. 1A and 1B. For instance, one or more computing devices (e.g., a processor of the vehicle 140 and/or the end-user device 150) may locally perform part or all of the steps described in FIG. 7 or a cloud device may perform such steps.

At step 710, the analytics server may retrieve driving session data from at least one sensor configured to monitor at least one driving attribute of a vehicle and at least one camera in communication with the vehicle. As discussed herein (e.g., FIGS. 2-6), the analytics server may retrieve driving data associated with a driving session that may include attributes of how the vehicle was operated and driver data (e.g., attributes of the driver while driving). As discussed herein, the camera may be an in-cabin camera (e.g., a camera facing the cabin of the vehicle) or a camera that is facing away from the cabin (e.g., a camera facing the road or exterior of the vehicle).

At step 720, the analytics server may execute an AI model trained based on previous driver data and driving session data to predict a score indicative of a likelihood of the driving session being associated with an event. As described herein (e.g., FIGS. 2-6), the analytics server may execute the trained AI model to determine a score for the driver and/or vehicle based on the latest driving session.

While executing the AI model, the analytics server may use all the data discussed herein that is collected for training the AI model. For instance, the analytics server may use the driving data collected via one or more sensors and one or more software associated with the vehicle. The data may be streamed to and ingested by the analytics server, such that it can be used to execute the AI model, in real-time or near real-time. In this way, the AI model may output the results discussed herein in real-time (or near real-time), such that the graphical user interfaces discussed herein can be populated in real-time (or near real-time).

At step 730, the analytics server may present for display on an electronic device in communication with the vehicle, the score and an indicator of data associated with the likelihood of the event. The analytics server may present the score and at least an indicator of data used by the AI model to calculate the score for display on at least one electronic device associated with the vehicle and/or the driver. For instance, the analytics server may display a prompt on the vehicle's infotainment system. In another example, the analytics server may transmit a push notification through a mobile application associated with the driver and/or the vehicle. The prompt may display the score calculated for the latest driving session and/or an insurance premium associated with the vehicle and/or the driver. If the score or the premium has changed based on the latest driving session, the analytics server may also display the previous score or premium. The analytics server may use various visual indicators to identify whether the score has increased or decreased (e.g., colors or arrows).

In addition to displaying the scores, the analytics server may also retrieve data associated with the driving session that caused the score to change. The analytics server may identify one or more attributes that caused the score to increase or decrease by determining whether this attribute was considered by the trained AI model to have caused the score to change. The analytics server may determine a list of attributes used by the AI model to calculate the score and a value indicative of how much each attribute has contributed to the score. As described above, the AI model may ingest many attributes (e.g., driving data for the previous driving session) to calculate the score. However, not all attributes may have the same weight when contributing to the calculated score. For instance, the AI model may assign a higher weight for the risk of forward collision combined with high speed than an illegal lane change. Therefore, while both factors contributed to a score that is indicative of a high risk of collision, the risk of forward collision combined with high speed is a higher contributor to the score.

The analytics server may use a variety of methods to identify top contributing factors to a score. For instance, the analytics server may use a softmax classifier protocol to calculate the probability of the score being affected by each attribute of the driving data. As a result, the analytics server may determine which attribute had the highest effect on the score calculated by the AI model.

After identifying the one or more attributes that affected the score, the analytics server may also retrieve an indication associated with the one or more attributes, such as a category of the attribute, values associated with the attributes, or a timestamp associated with the attribute. For instance, the analytics server may identify that the attribute that caused the score to change was the vehicle's speed when changing lanes. The analytics server may then identify a timestamp associated with the vehicle's speed when changing lanes. Using the timestamp, the analytics server may retrieve the corresponding data points. For instance, the analytics server may retrieve the vehicle's speed at the identified timestamp (e.g., 80 mph). The analytics server may then present the retrieved data in a prompt outputted on one or more electronic devices (e.g., the vehicle's infotainment system or the driver's mobile phone). The prompt may include the retrieved data point. For instance, the prompt may inform the driver that because the driver was driving the vehicle at 80 mph when changing lanes, the driver's score has decreased (e.g., the driver is now considered as riskier than before).

In some embodiments, the data needed to present the graphical user interfaces discussed herein may be encrypted, such that only authorized devices can access and present/display the data. For instance, in some embodiments, the raw data (e.g., driving data including various events and their corresponding data, such as an image of the driver during the event or a location of the vehicle during the event) may be directly communicated to the device presenting the graphical user interfaces discussed herein from a computer/processor of the vehicle. In order to address privacy concerns, the data communicated between the vehicle, analytics server, and/or the electronic device (e.g., the driver's mobile device) may be encrypted, such that only authorized devices can access the data.

The data may be encrypted using various methods, such as synchronous or asynchronous encryption protocols. For instance, in a non-limiting example, the data may be encrypted using a public key associated with a driver or their mobile device. As a result, the driver's mobile device may use their private key to asynchronously decrypt the data needed for the presentation of the graphical user interfaces discussed herein. In another non-limiting example, the electronic device (or any other device presenting the graphical user interfaces discussed herein) may use a common key (a key known to both parties) to encrypt and decrypt the data.

In a non-limiting example, driving session data is identified as having a hard brake and aggressive driving above the speed limit, which causes the analytics server to lower the driver's score. The driver may then be interested in receiving the location (e.g., map) of an occurrence of the hard brake and/or an image of the driver while committing the hard brake. As a result, the electronic device presenting the driver's score may communicate with the vehicle (associated with the driving session) to receive the data stored on a data repository associated with the vehicle. The image and location of the hard brake and aggressive driving may be stored by a processor of the vehicle because this data may be locally captured by the sensor(s) of the vehicle (e.g., in-cabin camera or a GPS sensor of the vehicle). The driver's mobile device may receive a data packet from the analytics server and/or the vehicle. Using a private key, the mobile device may decrypt the data received and present the graphical user interfaces discussed herein.

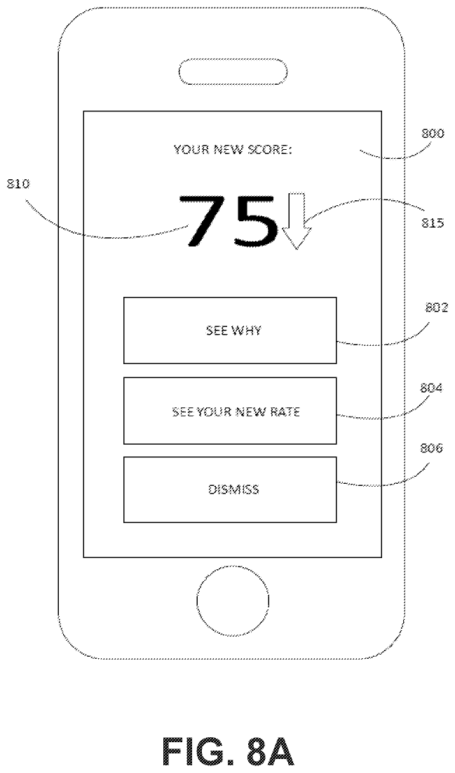

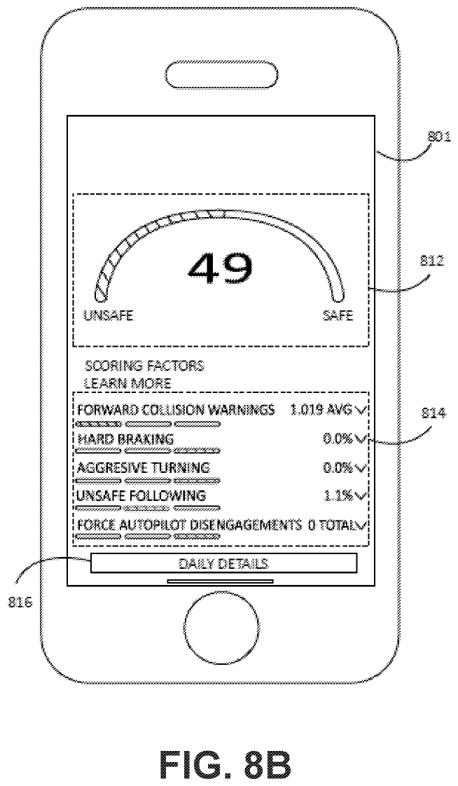

The analytics server may present, for display, a graphical user interface having a prompt 800 (depicted in FIG. 8A) on a mobile device associated with the driver. The analytics server may query a preauthorized list of electronic devices to identify the driver's mobile device. The analytics server may then transmit the prompt 800 to the identified mobile device. The prompt 800 may inform of their score 810 based on the recently-completed driving session. For example, as shown in FIG. 8A, a score may be on a scale of 1-100, and the prompt may include the new score 810 along with an indicator 815 of whether the score increased or decreased (e.g., shown by an arrow up or down). The prompt 800 may also indicate whether an insurance premium has been adjusted in view of any risky behavior identified during their last trip.

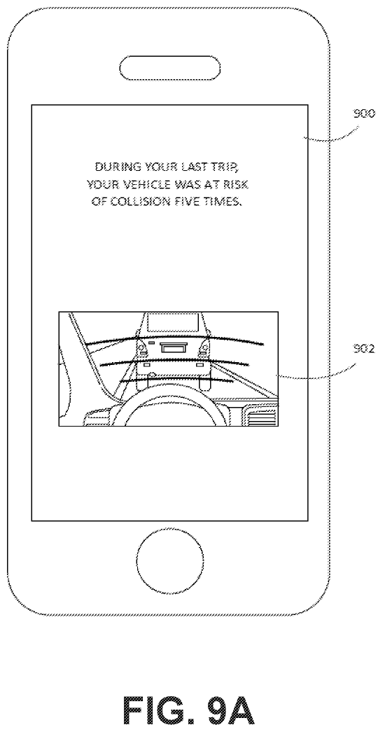

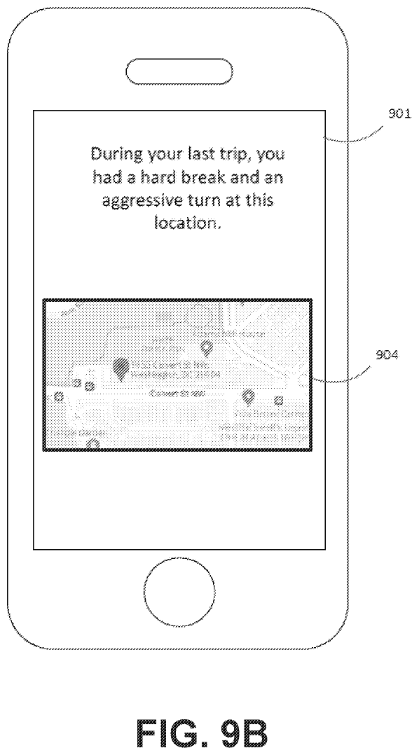

The prompt 800 may also include three interactive buttons 802, 804, and 806. When the driver interacts with the interactive button 802, the analytics server directs the driver to the graphical user interface 900 (depicted in FIG. 9A) describing the reason for the decrease in the score 810. Specifically, the graphical user interface 900 informs the driver that the vehicle was at risk of collision five times during the last trip. The analytics server may present an image 902 associated with an instance of risk of collision, such as where the vehicle was identified to be at risk of a forward collision with another vehicle. In other embodiments, the analytics server may display a video feed associated with the time period identified as risky driving (e.g., a camera feed from one or more cameras showing footage of when the vehicle was at risk of collision).

Alternatively, as a result of the driver interacting with the button 802, the analytics server may direct the driver to the graphical use interface 901, depicted in FIG. 9B. The graphical user interface 901 may include a map 904 indicating a location of an action performed by the driver that affected the driver's score. The graphical user interface may also include a description of why an action performed by the driver affected the driver's score. For instance, the map 904 may depict a location where the driver had a hard brake and an aggressive turn that caused the analytics server to lower the driver's score.

Referring back to FIG. 8A, when the user interacts with the interactive button 804, the analytics server may display a new insurance premium and other data identifying how the driver's rate has changed. The new premium may go into effect at that time or may be implemented at the next assessment of the driver's premium if the driver were to maintain that score. The analytics server may also display historical data trends and other metrics needed to understand the premium. The user may dismiss the prompt 800 by interacting with the interactive button 806.

In another embodiment, the analytics server may display the prompt 801, depicted in FIG. 8B. The analytics server may present for display a graphical user interface having the prompt 801 on a mobile device associated with the driver. The analytics server may transmit the prompt 801 to an authorized mobile device associated with the driver and/or the vehicle. The prompt 801 may include a graphical component 812 that includes a numerical score for a recently-completed driving session (e.g., score of 49). In some embodiments, the prompt 801 may be displayed in real-time during a driving session and the features of the prompt 801 may be updated in real-time (or near real-time).

As discussed herein, the score may be scaled on a 1-100 scale, such that the score is normalized and easily understood by the driver. The graphical component 812 may also include a graphical range of scores starting with the lowest score on one side (e.g., a score of 1 on the left indicating the most unsafe driving session) to the highest score on another (opposite) side (e.g., score of 100 on the right side indicating the safest driving session). The range of scores may also visually indicate the score calculated for the recently-completed driving session. For instance, as depicted, a portion of the bar indicating the range may be depicted as solid, such that the viewer can determine a relative position of their score.

Although the graphical component 812 is depicted as a partially filled bar, other embodiments may include other visual methods. For instance, other embodiments may include a vertical bar graph or hatch patterns and color patterns instead.

The graphical user interface may also include a graphical component 814 visually depicting and describing different factors contributing to the score calculated for the recently-completed driving session. For instance, the graphical component 814 may include five main factors monitored by the analytics server to evaluate the driving session. These factors may include forward collision warning, hard braking, aggressive turning, unsafe following, and forced autonomous driving or steering (e.g., auto-pilot) disengagement. The graphical component 812 may also include a horizontal bar for each factor. Each bar may visually indicate whether the analytics server has identified the driving data associated with that factor to be low, normal, or high risk. For instance, the bar corresponding to “forward collision warning” may be filled on the left side (and sometimes using a color indicating a low score or risky behavior, such as red). This indicates that the driving session included forward collision warnings (e.g., more times than a defined threshold). This also indicates why the driving session received a relatively lower score of 49.

In another example, the bar corresponding to “hard braking” is filled on the right side (and sometimes using a color indicating a high score or safe behavior, such as green). This indicates that the driving session included data indicating that the driver did not have a significant hard brake. In another example, the bar corresponding to “unsafe following” may be filled in the middle (and sometimes using a color indicating a medium score or medium risky behavior, such as yellow). This indicates that the driving session included a few events where the driver was following other cars too closely.

Each factor may also include a numerical value indicating the analytics server's evaluation of the driving session (as it is related to that factor). For instance, the “forward collision warning” factor may indicate a numerical value for the forward collision score per hour (e.g., as described in FIG. 5). In another example, the “hard braking” factor indicates that the driving session included no hard brakes.

Each factor may also include a description of the factor and how it affects the score. For instance, each factor may be presented as a collapsible indicator. When the analytics server determines that the user/driver has interacted with a factor, the analytics server may present more information regarding each factor. For instance, the analytics server may present a definition of each factor or how different scores/metrics are calculated.

For instance, the analytics server may display that “forward collision warnings” are audible/visual alerts provided to the driver (by the vehicle), in the event where a possible collision due to an object in front of the vehicle is considered likely without the driver's intervention. The analytics server may also provide an example of how forward collision warnings can be incorporated within the score. For instance, the analytics server may display that the analytics server may consider forward collision warnings per 1000 miles and may (or may not) cap the value at 101.9.

In another example, the analytics server may describe “hard braking” as backward acceleration in excess of 0.3 g (or any other defined threshold) or a decrease in the vehicle's speed by 6.7 mph (or any other defined threshold) in one second. Hard braking may be used to calculate the score as the proportion of time (expressed as a percentage) where the vehicle experiences backward acceleration of 0.3 g or more relative to the proportion of time where the vehicle experiences backward acceleration greater than 0.1 g (2.2 mph per one second). In another example, the analytics server may describe “aggressive driving” as left/right acceleration in excess of 0.4 g or any other defined threshold.

The driving data and their corresponding score can be segmented based on any time window identified by the driver/viewer. For instance, as depicted in FIG. 8B, when the analytics server determines that the driver/viewer has interacted with the button 816, the analytics server may display the same data described herein for a particular day (and not for each individual driving session discussed herein). In other examples, the driving data can be shown for a particular week or a month. Moreover, driving data (and the corresponding analysis) can be shown as a trend, such that the driver can view changes throughout a time window (e.g., trending over the past month).

The presentation of the graphical user interfaces discussed herein is not limited to a mobile application executing on the driver's electronic device (e.g., the driver's mobile phone as depicted in FIGS. 8A-9B). Additionally or alternatively, the graphical user interfaces discussed herein can be presented on any electronic device associated with the driver's account and/or an account associated with a vehicle (e.g., such that a parent can monitor their children's driving scores and other details). Moreover, the graphical user interfaces can be displayed on an electronic device of (e.g., associated with) the vehicle as well.

In another non-limiting example, the analytics server may display the depicted prompt on an electronic device associated with the vehicle itself, such as the vehicle's infotainment system (e.g., touchscreen 1000 depicted in FIG. 10). The analytics server may display a text notification informing the driver that their score was adjusted due to risky behavior during their last trip. The notification may also include images showing evidence of the risky behavior. For example, when the vehicle runs a red light, the analytics server may display an image 1002.

The analytics server may display any media element (e.g., picture, sounds, or video) corresponding to an event or action associated with the score. For instance, if an event or action (e.g., running a red light or aggressively changing lanes while speeding) is identified as a reason that the score has decreased, the analytics server may query a data repository (e.g., the local data repository of the vehicle or a cloud storage) and retrieve a media element associated with the event or action to be presented to the driver. For instance, a driver may be distracted and may be texting and driving. As a result, the in-cabin camera may capture an image of the driver texting while driving. That image may be displayed on a graphical user interface, such that the driver is aware of at least one reason that the driver's behavior has been identified as risky.

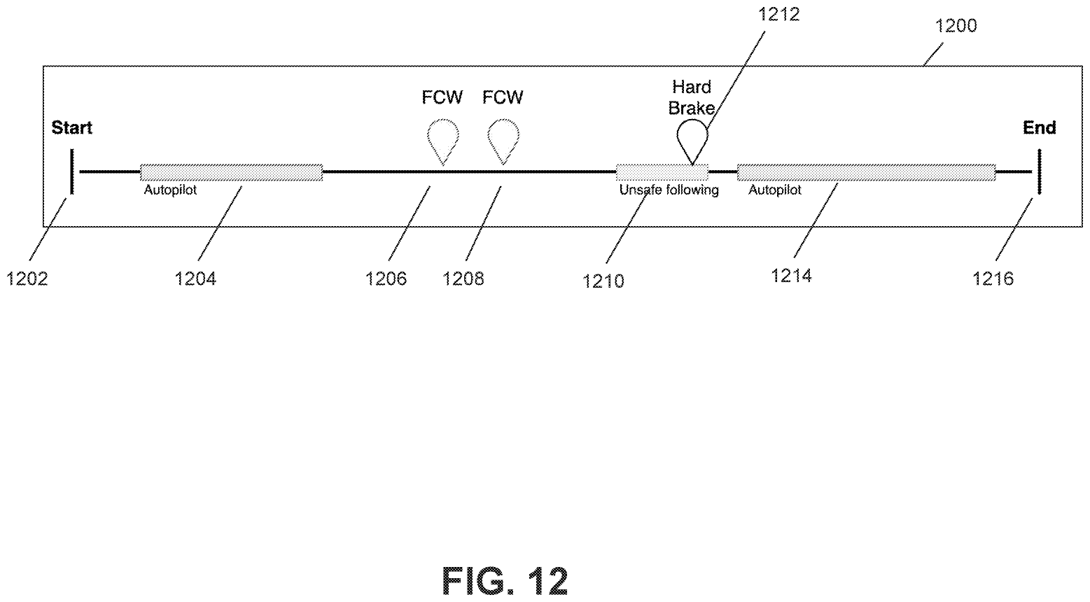

In some embodiments, the analytics server may present a timeline of the driving session that indicates different events and actions that affected the score. For instance, the analytics server may present the timeline 1200, depicted in FIG. 12, on an electronic device associated with the vehicle/driver. The timeline 1200 may be presented on any of the graphical user interfaces discussed herein (e.g., on a mobile device and/or in the vehicle). The timeline 1200 may correspond to a particular driving session, such as a driver's last driving session. However, in other embodiments, the timeline 1200 may correspond to a particular driving session selected by the driver, such as a driving session that caused the overall score to be decreased. Alternatively, the timeline 1200 may correspond to a start and end time-based on a selection by the driver.

The timeline 1200 may include a graphical indicator 1202 indicating a start to the driving session followed by a graphical indicator 1204 depicting a time window in which the driver used autonomous driving and/or steering capabilities of their vehicle. As discussed herein, the analytics server may not use driving data while the driver is using the autonomous driving mode. The timeline may also include the graphical indicator 1214 that similarly shows that the driver was using autonomous driving capabilities towards the end of the driving session.

The timeline 1200 may include graphical indicators 1206-8 depicting when the driving data indicated that the driver received a forward collision warning. Another graphical indicator 1210 depicts a time window in which the vehicle was identified to be following another car in an unsafe manner (e.g., closer than a defined threshold). Within the same “unsafe following” time window, the driver also had a hard brake, as indicated by a graphical indicator 1212. Finally, the timeline 1200 includes a graphical indicator 1216 depicting an end to the driving session.

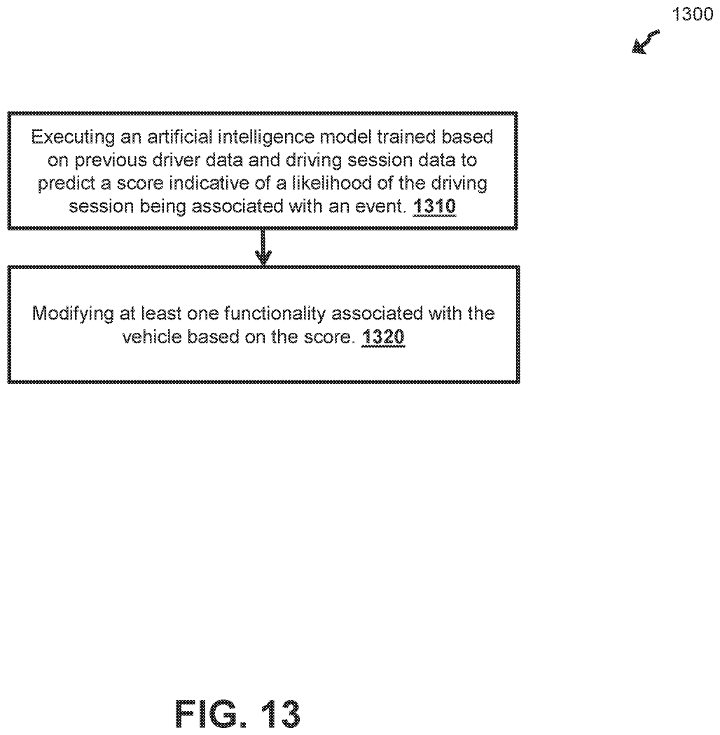

Referring now to FIG. 13, the method 1300 illustrates a flow diagram executed in an AI-enabled vehicle sensor data analysis system, according to an embodiment. The method 1300 may include steps 1310-1320. However, other embodiments may include additional or alternative steps, or may omit one or more steps altogether. The method 1300 is described as being executed by an analytics server (e.g., a computer similar to the analytics server 110a described in FIG. 1A). However, one or more steps of the method 1300 may be executed by any number of computing devices operating in the distributed computing system described in FIG. 1A and 1B. For instance, one or more computing devices (e.g., a processor of the vehicle 140 and/or the end-user device 150) may locally perform part or all of the steps described in FIG. 13 or a cloud device may perform such steps.

At step 1310, the analytics server may retrieve driving session data from at least one sensor configured to monitor at least one driving attribute of a vehicle and at least one camera in communication with the vehicle. As discussed herein (e.g., FIGS. 2-6), the analytics server may retrieve driving data associated with a driving session that may include attributes of how the vehicle was operated and driver data (e.g., attributes of the driver while driving). As discussed herein, the camera may be an in-cabin camera (e.g., a camera facing the cabin of the vehicle) or a camera that is facing away from the cabin (e.g., a camera facing the road or exterior of the vehicle).

Using various methods and systems discussed herein, the analytics server may generate a score indicative of a likelihood of the driving session being associated with an event, such as an accident.

At step 1320, the analytics server may modify at least one functionality of the vehicle (associated with the score) based on the score. The analytics server may apply one or more rules to the score and determine a functionality associated with the vehicle to be modified. In some embodiments, the one or more rules applied to the score may correspond to one or more thresholds. As a result, the score is compared against the threshold. The threshold, as used herein, may refer to a static threshold defined by a system administrator or a dynamic threshold that varies based on other factors, such as attributes of the driver (e.g., demographic data of the driver) or the vehicle (e.g., vehicles age), and the like.

If the score calculated for the driving session satisfies the threshold, the analytics server may modify one or more functionalities associated with the vehicle and/or the driver. Functionality, as used herein, may refer to any hardware or software capability that is associated with the vehicle and/or the driver associated with the driving session. In a non-limiting example, the analytics server may determine that a driver's score satisfies a safety threshold. As a result, the analytics server may disable one or more features of the vehicle. For instance, the analytics server may disable the autonomous driving or steering feature of the vehicle or disable acceleration boost for the vehicle. In another example, the analytics server may add or remove features, such as autonomous driving or steering (when the vehicle does not have that feature added), acceleration boost, ability to supercharge, electronic content presented by an electronic device of the vehicle (e.g., games or movies), and the like.

The analytics server may periodically modify the at least one feature in accordance with an updated score of the driver. Therefore, the modifications implemented may be reversible. For instance, when a driver's score is lower than 70/100 (an example of a defined threshold), the analytics server may continue allowing the driver to use the autonomous driving feature, when the driver's score does not satisfy the threshold (e.g., when the driver's score is lowered, such that the driver is not considered risky), the analytics server may remove the autonomous driving feature. However, at a subsequent time, when the driver's score exceeds 70/100, the analytics server may add the autonomous driving feature.

The modifications made by the analytics server may be specific to a vehicle or a driver. For instance, when a vehicle is identified to be used by multiple drivers, the analytics server may only disable/enable the features discussed above for a particular driver whose score satisfies the threshold. In a non-limiting example, when the vehicle is being driven by two drivers, the analytics server may disable acceleration boost for the first driver only while the second driver can utilize that feature.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A method comprising:
retrieving, by a processor, data associated with a set of driving sessions;
generating, by the processor, a training dataset by:
labeling, by the processor, a first subset of data that corresponds to at least one driving session that included a first event;
labeling, by the processor, a second subset of the data that corresponds to at least one driving session that included an indication of an airbag activation; and
training, by the processor, an artificial intelligence model using the training dataset, such that the trained artificial intelligence model is configured to predict a score indicative of a likelihood of a new driving session associated with a new driver being associated with at least the first event or airbag activation.

2. The method of claim 1, wherein the first event corresponds to an insurance claim.

3. The method of claim 1, wherein the data is received from a set of sensors of a set of vehicles associated with each driving session.

4. The method of claim 3, wherein at least one sensor within the set of sensors is configured to collect data associated with forward collision warnings, braking events, autonomous driving disqualifications, autonomous steering disqualifications, or lane departures.

5. The method of claim 1, further comprising:
transmitting, by the processor, the score to a software application configured to receive the score and generate an insurance rate.

6. The method of claim 1, further comprising:
presenting, by the processor, the score to be displayed on an electronic device.

7. The method of claim 6, wherein the electronic device is associated with a vehicle corresponding to the new driving session.

8. The method of claim 1, further comprising:
identifying, by the processor, a modification to at least one sensor.

9. The method of claim 1, wherein the score is calculated based on at least one attribute of the new driver associated with the new driving session.

10. The method of claim 1, wherein the set of driving sessions belongs to a predetermined drive cycle, wherein when the processor determines that a vehicle associated with a driving session does not have network connectivity, the processor excludes the driving session from the set of driving sessions.

11. A system comprising:
a computer-readable medium comprising non-transitory instructions that when executed, cause a processor to:
retrieve data associated with a set of driving sessions;
generate a training dataset by:
labeling a first subset of data that corresponds to at least one driving session that included a first event;
labeling a second subset of the data that corresponds to at least one driving session that included an indication of an airbag activation; and
train an artificial intelligence model using the training dataset, such that the trained artificial intelligence model is configured to predict a score indicative of a likelihood of a new driving session associated with a new driver being associated with at least the first event or airbag activation.

12. The system of claim 11, wherein the first event corresponds to an insurance claim.

13. The system of claim 11, wherein the data is received from a set of sensors of a set of vehicles associated with each driving session.

14. The system of claim 13, wherein at least one sensor within the set of sensors is configured to collect data associated with forward collision warnings, braking events, autonomous driving disqualifications, autonomous steering disqualifications, or lane departures.

15. The system of claim 11, wherein the instructions further cause the processor to:
transmit the score to a software application configured to receive the score and generate an insurance rate.

16. The system of claim 11, wherein the instructions further cause the processor to:
present the score to be displayed on an electronic device.

17. The system of claim 16, wherein the electronic device is associated with a vehicle corresponding to the new driving session.

18. A system comprising:
an artificial intelligence model; and
a server in communication with the artificial intelligence model, the server configured to:
retrieve data associated with a set of driving sessions;
generate a training dataset by label a first subset of data that corresponds to at least one driving session that included a first event;
label a second subset of the data that corresponds to at least one driving session that included an indication of an airbag activation; and
train the artificial intelligence model using the training dataset, such that the trained artificial intelligence model is configured to predict a score indicative of a likelihood of a new driving session associated with a new driver being associated with at least the first event or airbag activation.

19. The system of claim 18, wherein the first event corresponds to an insurance claim.

20. The system of claim 19, wherein the data is received from a set of sensors of a set of vehicles associated with each driving session.

21-101. (canceled)
